(19) United States
(12) Patent Application Publication
(10) Pub. No.: US 2004/0128198 A1
(43) Pub. Date: Jul. 1, 2004

(54) System and method for computer network-based enterprise media distribution

(76) Inventors: Linwood Register, Marietta, GA (US); Robert H. Powell, Idaho Falls, ID (US); Michael D. Landon, Idaho Falls, ID (US)

Correspondence Address: Michael F. Krieger, KIRTON & McCONKIE, Suite 1800, 60 East South Temple, Salt Lake City, UT, 84111, US

(21) Appl. No.: 10/735,350

(22) Filed: Dec. 12, 2003

Related U.S. Application Data
(63) Continuation-in-part of application No. 10/145,920, filed on May 15, 2002.
Application No. 10/145,920 is a continuation-in-part of application No. 10/146,192, filed on May 15, 2002.

(51) Int. Cl. G06F 17/60

(52) U.S. Cl. 705/14

(57) ABSTRACT

The present invention features an enterprise media distribution system or network-based in-store media broadcasting system comprising one or more, and preferably, a plurality of business chains, each business chain comprising a plurality of business locations; a media distribution platform or framework comprising one or more client player devices placed at each business location, each of the client player devices being independently supported and in communication with an internal audio/visual system installed and existing within in the respective business locations; independent customizable media broadcasts supported on each of the client player devices and comprising audio, visual, and/or informational media content thereon that may be specific to each of the particular business locations in which the client player device(s) is/are located; a chain network having at least one chain server, such as updating and caching servers, for servicing each respective business chain, said chain server in communication with each client player device in the respective business chain; a central server system comprising one or more central servers in communication with each of the chain servers in each business chain; a network configuration connecting each client player device to the chain servers to provide an exchange of information between the two; and a network configuration connecting the chain servers to the central server system to provide an exchange of information between the two.

### RELATED APPLICATIONS

This application is a continuation-in-part application and claims priority to U.S. patent application Ser. No. 10/145,920, filed May 15, 2002, and entitled, “System For And Method Of Doing Business To Provide Network-Based In-Store Media Broadcasting;” and to U.S. patent application Ser. No. 10/146,192, filed May 15, 2002, and entitled, “Providing a Multi-tier Enterprise Level Application,” each of which are incorporated by reference herein in their entirety.

### BACKGROUND

1. Field of the Invention

The present invention relates to in-store media broadcasting, and particularly to a system for distributing and/or broadcasting various media, and a method of doing business to provide customizable media broadcasts, namely audio (e.g. music and music playlists), video, and other information (e.g., advertisements), to one or more business locations by way of an enterprise media distribution framework.

2. Background of the Invention

In today's highly industrialized and commercial business oriented world, it is not uncommon at all for one to walk into a retail or other commercial business location, whether housing a business operating for profit or a non-profit organization, and find various devices or other items, or even services, designed to make that customer or patron more comfortable, relaxed, and at ease while shopping or carrying on their intended purpose for visiting the business location. Indeed, it has been shown that those business locations offering a comfortable and relaxed atmosphere have a higher chance of securing repeat customers.

One of the most common services used to create a more inviting and relaxed atmosphere is the broadcast of music throughout the business location. This is typically done via an audio system installed in the business location allowing the music to be heard throughout the business location. In addition to playing music, various advertisements and announcements can be made to customers and others visiting the business location for the purpose of keeping them updated and informed of events, items on sale, and/or various promotional items or services being offered by the merchant or service provider.

In many instances, the music being broadcast throughout the business location is provided not only to that business location, but to many others as well through a provider specializing in the broadcasting of music to such a location. Typically, this has been done in the past through a satellite based system, wherein the satellite is uploaded with one or more play lists and other information. Once uploaded, the satellite bursts the information down to a receiver located at a business location. The information can then be pulled of the receiver and directed through an audio system installed in the business location. This service can be provided to one or a plurality of business locations. Moreover, the business model that has been used to provide broadcast music to the several business locations is through a franchising operation, wherein those wishing to have music broadcast through their business locations pay a healthy annual fee for such services.

Although music is being provided, there are several inherent difficulties and limitations associated with the above-described system and method of doing business, namely being limited by an expensive and unaccommodating satellite infrastructure. First, the information that is uploaded to the satellite and that is subsequently burst down from the satellite to the satellite receivers is uniform, meaning that each receiver receives the same play list or the same advertisement or the same announcement. As such, each merchant or service provider is forced to broadcast through their business location the same thing as the next merchant or service provider. In other words, there is little or no customization that can be incorporated into the broadcast. This has severely limiting effects in that a merchant is forced to broadcast information that he/she may or may not want; or the merchant or service provider is forced to interrupt the broadcast to advertise or announce those items that would be of particular interest to those visiting his/her business location. For example, if a merchant wanted to broadcast an advertisement for one week at a certain time that promoted an in-store object for sale, this would not be possible with current systems except through interruption of the normal broadcast by the merchant.

Second, there is no way to update the broadcast at will as the merchant or service provider must wait until the next scheduled download from the satellite system.

Third, the business method used to provide broadcast music and advertisement information is limiting and burdensome to the individual merchants or service providers. Merchants and service providers spend literally millions of dollars a year to receive a broadcasting service like the one described above. As this is an added expense, this type of broadcasting service directly impacts and reduces overall profit margins. Moreover, the satellite-based system does not allow for each business location to customize their broadcast and receive updates as desired. Still further, this business plan does not serve as a revenue generating source for the business location, but is instead, as stated, an added expense. Still further, as a franchising operation, it is difficult to control the distribution system, thus making it difficult to implement any advertising sales strategy or to become affiliated with various businesses for the purpose of advertising.

Other systems and methods are also accounted for that are capable of providing music broadcasting. One such system and method is News America, which is in partnership with Muzak. News America sells in-store radio ads to its advertising client base via its SmartSource division. SmartSource sells in-store advertising to CPG companies under the SmartSource brand name which offers products such as shelf-talkers, shopping cart advertising and in-store radio advertising. News America piggy-backs on the Muzak satellite system to deliver its radio advertising broadcast.

Because News America utilizes satellite technology for advertising broadcast, it is not able to offer the same level of targeting, customization and creative content flexibility of IBN. News America is solely focused on selling direct promotions to trade marketing groups—it does not sell to consumer advertising groups/agencies.

Another is MP3.com, which is a wholly owned subsidiary of Vivendi Universal, S.A. and has built a technology infrastructure designed to facilitate the storage, management, promotion and delivery of digital music via the Internet. The company's Business Music Services program allows retailers to provide in-store music and audio advertisements to grocery stores and other retailers.

MP3.com provides on-premise servers to host the music and advertising service. Digital music and ad files are transferred via the Internet. MP3.com out sources the installation, service and maintenance of the computers as well as advertising sales. Monthly fees for MP3.com's service generally range from $30-$80 per month per store.

Because MP3 does not directly control advertising sales, it is unable to offer a significant level of revenue share to its retailers. In addition, MP3 utilizes material from its existing music library that generally consists of artists who have not signed with a major label and are therefore relatively unknown. This music is less familiar and therefore less attractive to retailers.

Another such system and method is DMX/AEI, which was founded in 2001 through the merger of AEI Music Network and the Liberty Digital subsidiary DMX Music. DMX/AEI is a distributor of music to businesses and homes via cable, satellite, CD's and the Internet. DMX/AEI offers up to 120 channels of stereo-quality digital music and primarily serves clothing and luxury retailers. DMX/AEI does have a satellite-delivered marketing product called AdNet. Monthly fees for DMX/AEI's music service range from $50-$100 per store.

However, DMX/AEI is limited by its expensive satellite infrastructure. It cannot offer the same level of customization and/or targeting for music or advertising. In addition, because it is focused on apparel and luxury retailers, it cannot offer CPG and Pharmaceutical advertisers national coverage or messaging at the point of sale.

Still another is Catalina Marketing Corporation (Catalina), which developed the Catalina Marketing Network. The Catalina Marketing Network is a system that enables manufacturers and retailers to identify customers based on purchase behavior and distribute incentives at the point of sale. Catalina's main product gives grocery stores and CPG companies the capability to print coupons for competing products during the checkout process.

While Catalina is very successful, their programs are limited and appeal to trade marketing groups who are looking to directly increase sales via coupon promotions. Therefore, the bulk of its advertising revenue will come from consumer marketing groups who are concerned with targeted reach.

Finally, another is Premiere Retail Networking (PRN). PRN partners with retailers and advertisers to create in-store television and interactive networks that broadcast news, product information, entertainment and advertising to viewers while they shop. PRN's customers include Wal-Mart, Sam's Club and Circuit City.

While PRN has shown initial success with both retailers and advertisers, there are significant limitations and shortfalls with PRN's service. First, radio is less disruptive to the shopping experience. Customers typically do not want to watch television while they are shopping at the supermarket and/or drugstore—they simply want to make their purchases and leave. Second, most supermarkets and drugstores do not have the space to house large screens with viewers. Third, because of the capital infrastructure required, the cost of implementing PRN's system is much higher.

As such, there are many shortcomings of prior art systems, services, and methods of doing business to provide broadcasting services coupled with advertising ventures.

### SUMMARY AND OBJECTS OF THE INVENTION

In accordance with the invention as embodied and broadly described herein, the present invention in-store, enterprise media distribution and broadcasting system features a proprietary enterprise media distribution framework or platform supported by and/or operated by several software modules designed to carry out the functions of the in-store media broadcasting system.

In one exemplary embodiment, the enterprise media distribution platform or framework comprises one or more, and preferably, a plurality of client player devices placed at a plurality of business locations, each of the client player devices being independently supported and in communication with an internal audio/visual system installed and existing within in the respective business locations; a customizable media broadcast supported on each of the client player devices and comprising audio, video, and/or informational media content thereon that may be specific to the particular business location in which the client player device(s) is/are located; a central server system comprising one or more central servers in communication with each of the independent client player devices; and a network configuration connecting each client player device to the central server network to provide an exchange of information between the two.

In another exemplary embodiment, the enterprise media distribution system comprises one or more, and preferably, a plurality of business chains, each business chain comprising a plurality of business locations; a media distribution platform or framework comprising one or more client player devices placed at each business location, each of the client player devices being independently supported and in communication with an internal audio/visual system installed and existing within in the respective business locations; independent customizable media broadcasts supported on each of the client player devices and comprising audio, visual, and/or informational media content thereon that may be specific to each of the particular business locations in which the client player device(s) is/are located; a chain network having at least one chain server, such as updating and caching servers, for servicing each respective business chain, said chain server in communication with each client player device in the respective business chain; a central server system comprising one or more central servers in communication with each of the chain servers in each business chain; a network configuration connecting each client player device to the chain servers to provide an exchange of information between the two; and a network configuration connecting the chain servers to the central server system to provide an exchange of information between the two.

The central server component includes application and database servers, as well as file storage devices to store and disseminate the media content. The central server is the intelligence center of the in-store media broadcasting system of the present invention and preferably communicates with all other components connected within the framework or platform using JDBC, FTP, RMI, HTTP, and HTTPS protocols.

The client player devices or components are essentially computers located at each business location and include software application modules that function to play and log the media broadcast. The client player device(s) also functions to connect to the central server for updates, and to receive upgrades of the software and broadcast content, including music play lists and advertisements, if available. The client player device(s) preferably communicates with the central server using protocols, such as JDBC, FTP, HTTP, HTTPS, and RMI protocols, and using XML-RPC.

The present invention in-store media broadcasting system further comprises one or more system network managers that function to automate and manage the in-store media broadcasting system. This component is an independent computing device that may or may not be located on the central server. Indeed, it may be separate from the central server. The network manager component is in communication with the central server through the network configuration and is operated by IBN personnel. The system network manager component comprises a suite of software modules used to automate business functions, such as creating and modifying contracts, advertisements, and schedules. This component also provides reports to track the status of these specific functions. The network manager preferably communicates with the central server using RMI, HTTP, HTTPS, and JDBC protocols.

The present invention in-store media broadcasting system further comprises one or more chain managers operated by business location personnel, and includes software modules designed to manage each client player device in each store in the chain and the media content contained thereon. This component is preferably a computing device separate from the client player devices, but may reside on one or more client player devices. The chain manager component communicates with the each client player device using the XML-RPC protocol, and with the central server using the RMI protocol.

As stated, the in-store media broadcasting system comprises several proprietary software application modules functioning on one of the above-identified components to allow the in-store media broadcasting system to operate as intended. Each of these are discussed in detail below.

The broadcast or media content preferably comprises music organized into music play lists according to various criteria (e.g. genre, date, etc.), advertisements, and announcements.

The present invention also features a unique method of doing business to provide in-store media broadcasting to one or more business locations. Not only is the business model capable of providing in-store media broadcasting, but a national radio-advertising platform or network focusing on major retailers and service providers throughout the country is also contemplated. The present invention system and service gives retailers and service providers the ability to broadcast customized music and messaging to their customers. In addition, the radio-advertising network provides a targeted advertising venue for consumer marketing companies and, unlike any other media, allows them to advertise products to select and targeted customers at the point of sale, which style of advertising can be much more effective in terms of success and the number of relevant customers the advertisements actually reach.

The business method or model of the present invention is capable of providing music service to retailers and service providers at a fraction of the cost of prior art business methods or models. In addition, because of the unique advertising revenue sharing program contemplated and integrated for use with the in-store media broadcasting system, retailers and service providers can transform what was once an operating expenditure into a revenue generator.

In addition to providing in-store media broadcasting services and revenue sharing capabilities to retailers and service providers, the present invention business method contemplates store-generated ads at a nominal fee which represents yet another cost savings benefit to the retailer. The in-store media broadcasting network is appealing to advertisers because it delivers a highly targeted audience at the point of sale. For example, typical grocery shoppers, women 18+, are primary targets for a wide range of consumer products; they are the gatekeepers for other household purchasing and they make activity decisions for the entire family. In addition, because virtually one member of every household shops at the grocery store, the in-store media broadcasting network offers tremendous depth and breadth of coverage.

### BRIEF DESCRIPTION OF THE DRAWINGS

The foregoing and other objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 illustrates a general overview of the in-store media broadcasting system according to a preferred embodiment of the present invention;

FIG. 2 illustrates a diagram illustrating the physical components of the client player device;

FIG. 3 illustrates the communication between the client player device and the central server system as being accomplished through a global user network, such as the Internet;

FIG. 4 illustrates the communication between the client player device and the central server system as being accomplished through a direct network connection; and

FIG. 5 illustrates the communication between the client player device and the central server system as being accomplished through a leased line connection;

FIG. 6 illustrates the communication between the client player device and the central server system as being accomplished through a dial-up modem connection;

FIG. 7 illustrates an exemplary operating environment of the media distribution system utilizing a chain server servicing a plurality of chain business locations and the relationship between the chain servers and the central server system;

FIG. 8 illustrates a more detailed view of one particular chain business utilizing the media distribution system of the present invention according to one exemplary operating environment in which a chain server is utilized;

FIG. 9 is a flow chart illustrating the steps taken to exchange information between the client player device and the central server according to a preferred embodiment of the present invention;

FIG. 10 is a flow chart illustrating the steps that are required to initiate an in-store broadcast according to a preferred embodiment of the present invention;

FIG. 11 is a flow chart illustrating the preferred method of doing business of providing a network-based in-store media broadcasting system;

FIG. 12 illustrates the broadcasting infrastructure according to a preferred embodiment of the present invention; and

FIG. 13 illustrates a flow diagram, along with several features, of the advertising method according to a preferred embodiment of the present invention.

### DETAILED DESCRIPTION OF THE PREFERRED EMBODIMENTS

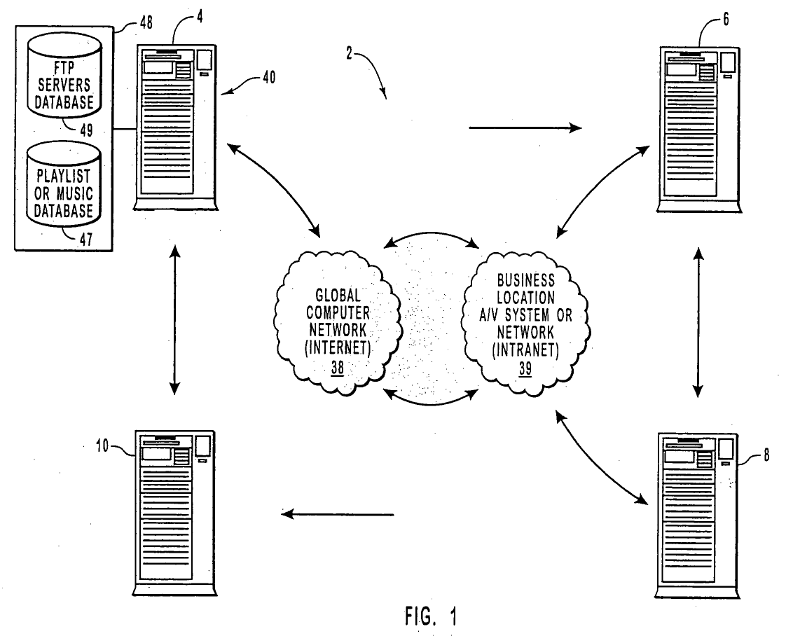

It will be readily understood that the components of the present invention, as generally described and illustrated in the figures herein, could be arranged and designed in a wide variety of different configurations. Thus, the following more detailed description of the embodiments of the system and method of the present invention, and represented in FIGS. 1 through 13, is not intended to limit the scope of the invention, as claimed, but is merely representative of the presently preferred embodiments of the invention.

The presently preferred embodiments of the invention will be best understood by reference to the drawings wherein like parts are designated by like numerals throughout.

The present invention features a method, system, and service for providing in-store media distribution and broadcasting of audio (music, announcements, etc.), visual (video, etc.), advertisements, and other informational content (collectively referred to as “content” or “broadcast”) to a retail business location, as well as a method of doing business to provide such in-store media broadcasting services. The definition of a business location is intended to mean any commercial retail store or outlet store (e.g., shopping mall, grocery store, convenience store, etc.), any type of commercial service oriented business (e.g., a dental or doctor's office, etc.), or any other type of location or facility that is preferably visited by the public, whether it be a location in which a business is being operated for profit, or one featuring a non-profit organization. A business location may also be defined as one particular location or facility existing within a business chain or a chain of business locations. And, a business chain may be defined herein as a plurality of business locations, stores, facilities, service facilities, etc. associated with one another in one or more ways. In essence, the present invention is intended to be adaptable to any location in which it would be desirable to utilize the technology of the present invention as discussed and described herein and illustrated in the accompanying Figures. Moreover, the term “in-store” will be used to describe the broadcasting system and method as it pertains to any of the above identified business locations. The term “in-store” is therefore not meant to be limiting in any way.

In accordance with the discussion and description set forth herein, the following more detailed description of the preferred embodiments will focus on two key areas, the first being the particulars of the in-store media broadcasting system, including the physical structures and network setup configuration, as well as the software application modules used to implement this system and to provide the broadcast media to the several business locations. The second area of focus will be on the associated or corresponding business method crafted to provide network-based media broadcasting services to the several business locations. Each of these are discussed below as they specifically relate to one another.

### Enterprise Media Distribution and Broadcasting System and Proprietary Enabling Software

The present invention features a system and method for providing digital in-store media broadcasting to one or a plurality of business locations, whether these business locations are independent of one another, in a group, exist within a chain, or any other arrangement. Preferably, the system and method are operated on a membership basis, with each member being defined as a member participant. A member participant may comprise a business owner of one or more business locations, chains, or groups, or a service provider of the same.

The system features an enterprise media distribution framework comprised of various hardware and software components that interact with each other to carry out the intended function of the present invention. The particulars of the system are discussed below. However, while the system and its proprietary software, the network or communications, and the method of doing business are all specifically described, such descriptions are provided with the intention of encompassing like-systems or like-devices or like-methods, those of which are not specifically described or mentioned herein, but would be obvious to one ordinarily skilled in the art.

With reference to FIG. 1, the concept of the present invention provides a unique paradigm shift from prior art in-store media broadcasting delivery services such as those described above. Instead of the particular delivery mechanism being satellite based, the present invention in-store media broadcasting system 2, in its simplest form, features a computer network-based system, such as an Internet or other computer network based system, comprising one or more computer systems, namely a central server system 40 located at a central location that is in communication with at least one, and preferably several or a plurality of, client player devices 6 located on the actual physical premises or store fronts of the several respective business locations.

Communication between central server system 40 and client player devices 6 is accomplished typically through a type of computer networking setup and configuration, shown in FIG. 1 as central server system being connected to a global user network such as the Internet 38, which is in turn connected to a local business location or business chain network, such as an Intranet 39. Central server system 40 comprises one or more central servers 4 housing a storage medium 48 comprising at least a play list or music database 47 and a remote file server database 49. These computer systems comprise the primary make-up of the in-store media broadcasting system of the present invention and are discussed in detail below. In-store broadcasting system 2 also comprises other computer systems, such as a chain manager 8 and a system network manager 10. Chain manager 8 is a computer system in communication with one or more client player devices 6 located within an identified chain and is used to monitor and manage each client player device within a chain. System network manager 10 is also a computer system controlled by network personnel (the system administration team) and is in communication with central server(s) 4. Each of these systems is discussed in greater detail below.

Incorporated into the discussion of the physical components of the in-store media broadcasting system are the proprietary software application modules that enable the system to operate and function as intended.

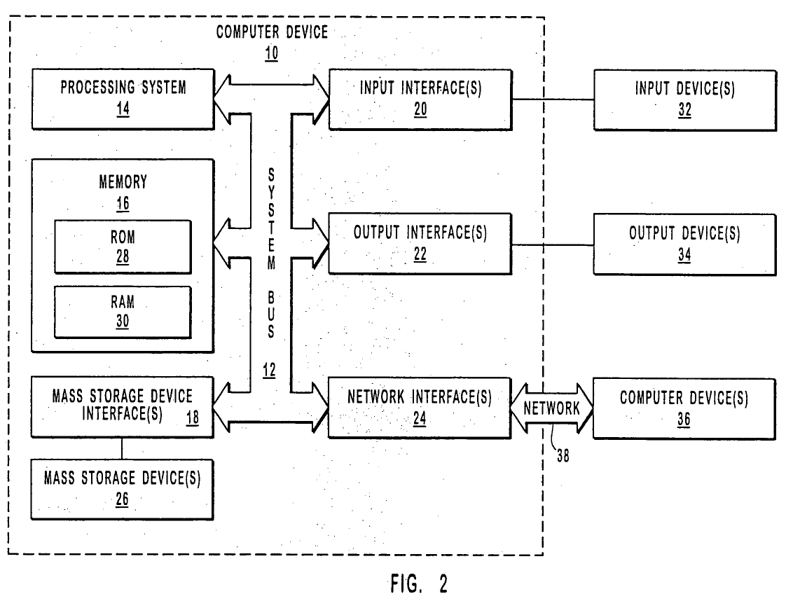

In reference to FIG. 2, each computer system identified above, namely the client player device, the central server, the chain manager, and the system network manager, comprise several known components them allow it to carry out and perform their intended functions, respectively. Specifically, each computer system typically comprises a system bus 12, which may be configured to connect various components thereof and enables data to be exchanged between two or more components. The system bus may include one of a variety of bus structures including a memory bus or memory controller, a peripheral bus, or a local bus that uses any of a variety of bus architectures. Typical components connected by the system bus include a processing system 14 and memory 16. Other components may include one or more mass storage device interfaces 18, one or more input interfaces 20, one or more output interfaces 22, and/or one or more network interfaces 24.

Processing system 14 includes one or more processors, such as a central processor and optionally one or more other processors designed to perform a particular function or task. It is typically the processing system that executes the instructions provided on a computer readable media, such as on a memory device, a magnetic hard disk, a removable magnetic disk, a magnetic cassette, an optical disk, or from a communication connection, which may also be viewed as a computer readable medium.

Memory device 16 includes one or more computer readable media that may be configured to include or includes thereon data or instructions for manipulating data, and may be accessed by the processing system through the system bus. The memory may include, for example, ROM 28, which is used to permanently store information, and/or RAM 30, which is used to temporarily store information. ROM 28 may include a basic input/output system (“BIOS”) having one or more routines that are used to establish communication, such as during start-up of the respective computer systems. RAM 30 may include one or more program modules, such as one or more operating systems, application programs, and/or program data.

One or more mass storage device interfaces 18 may be used to connect one or more mass storage devices 26 to the system bus 12. The mass storage devices 26 may be incorporated into or may be peripheral to the computer system and allow each system to retain large amounts of data. Optionally, one or more of mass storage devices 26 may be removable from the computer system. Examples of a mass storage device include hard disk drives, magnetic disk drives, tape drives and optical disk drives. A mass storage device may read from and/or write to a magnetic hard disk, a removable magnetic disk, a magnetic cassette, an optical disk, or another computer readable medium. Mass storage devices 26 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may also be employed to enable a user to enter data and/or instructions into the respective computer systems through one or more corresponding input devices 32. Examples of such input devices 32 include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices to the system bus include a serial port, a parallel port, a game port, a universal serial bus (“USB”), a firewire (IEEE 1394), or another interface.

One or more output interfaces 22 may also be employed to connect one or more corresponding output devices 34 to system bus 12. Examples of output devices 34 include a monitor or display screen, a speaker, a printer, and the like. A particular output device may be integrated with or peripheral to each computer system. Examples of output interfaces 22 include a video adapter, an audio adapter, a parallel port, and the like.

In this preferred embodiment, each client player device 6 is essentially a stand-alone, headless computer comprising at least a central processing unit, one or more storage mediums thereon, and an operating system capable of executing and carrying out the intended functions of the client player device. The term “headless” meaning that no input or output devices are connected to the client player device, such as a monitor or keyboard, etc. The functions are therefore directed by systems network manager 10 or chain manager 8, or central server 4, rather than locally by client player device 6. This is not to say however, that it is not preferred to incorporate or couple one or more input/output devices to client player device 6 to allow or enable control directly form a client player device 6, as some member merchants may wish to control the functioning of client player device 6 at the local in-store level. Such a featured setup or configuration is therefore contemplated and provided for by the present invention.

Central server 4 is also typically headless, but chain manager 8 and system network manager 10 comprise several of the input and output devices described above, such as a keyboard, mouse, monitor, speakers, printer, etc. in order to allow operation of the computer system by various personnel and control of client player device 6.

An apparent and significant advantage of the present invention in-store media broadcasting system from other prior art systems is the platform independence existing between each client player device and/or chain manager. Therefore, the present invention makes it possible to operate upon one client player device independently of another client player device, the term operate meaning to extract information, transfer information, upload or download software application modules, update the software modules, communicate with the central server, monitor the play lists and advertisements, manage the functions of the client player devices, etc.

The operating system used to control each client player device 6, chain manager 8, and system network manager 10 is preferably the Linux® operating system, and while the discussion above relates to the use of the Linux® operating system, other embodiments of the present invention may embrace the use of other operating systems, such as a Microsoft® operating system, an Apple or Macintosh® operating system, a System V Unix® operating system, a BSD Unix® operating system, an OSF Unix® operating system, an IBM® Mainframe MVS operating system, and/or another operating system. In addition to the components of each computer system described and the operating systems anticipated, other components are intended to be included in each computer system as commonly known by one ordinarily skilled in the art. Moreover, each computer system is capable of storing and executing at least one application software program thereon in accordance with the teachings of the present invention.

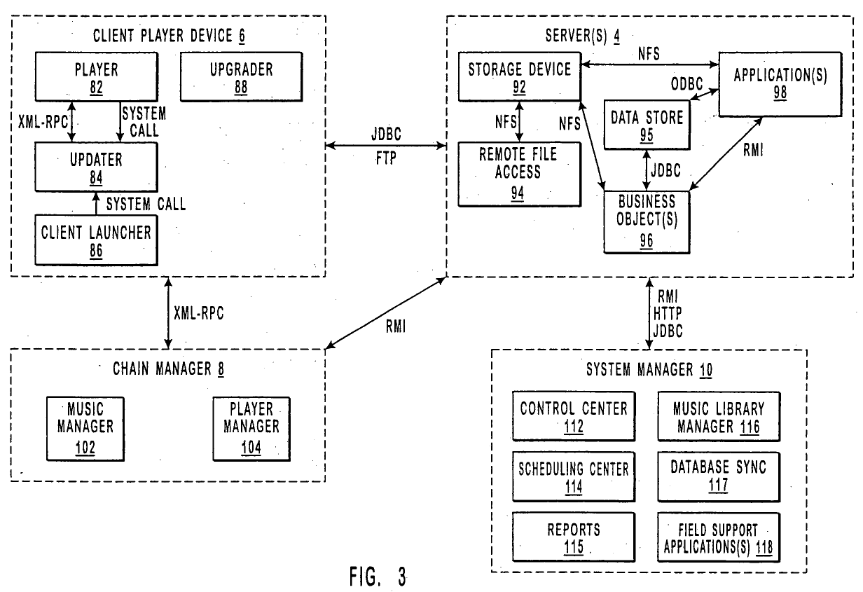

In reference to FIG. 3, each computer system identified and generally discussed above, is discussed in further detail herein.

Client Player Device(s)

Each client player device 6 participating in the service and integrated into in-store media broadcasting system 2 is located at a remote business location and is capable of communicating directly with central server 4 to receive or download play lists, advertisements, schedules, video (streaming or still) and various other information pertinent to the operation of in-store broadcast system 2 that are stored and supported on central server 4. Each client player device 6 is also capable of uploading informational content to central server 4, such as reports, logs, error messages, or any other pertinent information related to how the system is performing or any special requests by the member participants, which are typically the operators or owners of the business location. Thus, a two-way open communication is contemplated by in-store media broadcasting system 2.

Client player device(s) 6 also comprise(s) one or more application software modules executable thereon. These software modules function to execute the operations of in-store media broadcasting system 2 and are proprietary applications. These proprietary software modules are discussed in greater detail below.

In regards to in-store media broadcasting system 2, each client player device 6 is initially equipped with a default play list stored on one of its memory storage devices 16 prior to being put into operation in a business location. The default play list comprises songs grouped in any desirable order, such as by genre, date, or a combination of these. This default play list serves as the base play list that may later be modified, updated, etc. through communication with the central server. Another significant function of the default play list is to provide a foundational play list, meaning that no matter what happens or what errors occur to any future downloaded play lists, there is always a play list that may be defaulted to in order to prevent any down-time of in-store media broadcasting system 2. As such, the default play list ensures that continuous and uninterrupted in-store media broadcasting is achieved. The default play list may not be, and typically will not be, the primary play list. However, although secondary or lower, the default play list remains intact and ready to become the primary play list should certain circumstances require.

As an alternative embodiment, any business location may utilize one or more client player devices 10 located on its premises depending upon the particular need of the business location operator or owner (i.e., a client player device placed on each floor of a multiple floor building with each device playing different play lists and/or advertisements), but for purposes of discussion herein, it will be assumed that each business location has only a single client player device located on its premises to control the in-store media broadcasting of that business location.

FIG. 3 illustrates client player device 6 and the several application components existing thereon that allow client player device to function as intended. Specifically, client player device or component 6 comprises a music or media player 82, an updater 84, a client player device launcher 86, and an upgrader 88.

Media or Music Player. Music or media player 82 comprises an application that creates a schedule for playing ads and media files, chooses media files to play according to an algorithm, plays media files, and logs ads and media files that have been played along with any errors that occur. It also includes an XML Remote Procedure Call (XML-RPC) server and an audio dynamic range compressor/expander for leveling the volume of media files. Music or media player 82 communicates with updater 84 using XML-RPC. Music or media player 82 also invokes updater 84 via system calls.

An XML-RPC is a protocol that allows a program on one computer to execute a program on a server computer. The client program sends an Extensible Markup Language (XML) message to the server with appropriate arguments and the server returns a message containing the results of the program executed.

Media player 82, through its proprietary application software, allows client player device 6 to communicate with central server 4, to execute the commands received from central server 4, to carry out those commands within the internal system of the business location, and to perform any other functions of the present invention in-store media broadcasting system 2. The internal system of the business location is intended to mean the particular audio or audio/visual system installed and used within the business location to broadcast music, video, advertisements, announcements and other information throughout the store. As such, each client player device 6 must be integrated into the internal system of the business location. In essence, media player 82 allows each client player device 6 to perform its intended function of broadcasting music, video, advertisements, and any other information throughout the business location using the internal audio/video system of the business location.

Again, none of the application software of media player 82, nor any of the other applications identified herein, will be discussed in great detail with respect to their application logic, but instead will be presented generally in order to sufficiently describe and cover the operation and intended workings of the present invention broadcasting system as applicable to the scope of coverage intended herein.

One of the primary functions of client player device 6, and particularly media player 82, is to create a schedule for playing music, video, advertisements, announcements, and any other information that may be broadcast over an internal audio/visual system installed in the business location. This schedule is a dynamic schedule in that it is capable of automatic or manual modification and automatic, manual, and/or continuous update as required and desired by the member participant. The schedule is a unique aspect of the present invention because it allows each member participant to customize the broadcast independent of any other broadcast. Specifically, media player 82 plays the music play lists, video feeds, advertisements, and other content according to the schedule as defined by the specific content requested by the member participant.

Play lists are defined as or comprise a media component (i.e., a music play list, a video feed, etc.) that specifies one or more music genres weighted by percent for playback at scheduled dates and times or one or more video feeds weighted by percent for playback, and an advertising component (i.e., an advertisement play list) that specifies zero or more ads for playback at scheduled dates and times. There are two types of play lists, a default play list and downloadable, customizable and modifiable play lists. Each client player device is on a schedule as to when songs are played, what types of songs are to be played, when ads are played, date sensitive play lists (Christmas, etc.), and others. This schedule is modifiable and can be customized in any way imaginable. In addition, each member participant or business location can customize their particular broadcast independent of any other member participant or business location. The play list schedule is determined by an algorithm. For example, there always exists a default play list, which preferably is not modifiable. However, other play lists may be created and tailored to suit the needs and wants of each member participant. It is these additional play lists that are customizable and modifiable to broadcast any type of music (e.g. particular genre, artist, time period, etc., and/or grouping of these, etc.), at any time, for any length, etc. For example, during the Christmas holiday season, a certain number (and/or type, artist, style, etc.) of Christmas songs may be designated to begin playing at the beginning of the Christmas holiday season, such as the day after Thanksgiving. As the holiday season progresses and nears closer to Christmas, the percentage of Christmas songs may be increased. As another example, if you want to tell the play list to play a certain type of music from 8-5 and then another type from 5-10 this also can be done. Any arrangement and modification is possible. No limitations exist other than the default play list may not be changed. You can even plan a play list or play lists for an entire week, month or year. Again, there are numerous possibilities. In light of this, all of the possible arrangements that may be created for the broadcast are not included herein. However, one ordinarily skilled in the art will recognize the possible arrangements for broadcast that can be made. As such, those specifically described herein are only meant as examples and are not meant to limit the present invention in-store media broadcasting system and method in any way.

Referring to the default play list, this play list is intended to cover every day and every time possible. Any additional customized or modified additional play lists downloaded from central server 4 are based off the default play list. These additional play lists are intended to either override, cause to go inactive, or compliment the default play list, but never to entirely supplant the default play list. Thus, in case of error or other problems occurring with the additional customizable and modifiable play lists, the default play list may be activated to provide continuous, uninterrupted music to the business location. In this way, the default play list functions as the base or foundational play list in which all other play lists are based.

Once one or more play lists are downloaded, each client player device 6 is capable of searching through each play list until it finds one that says what it should be doing at that time according to the dynamic schedule. Client player device 6 will then proceed to play that play list in accordance with the parameters defined for the play list and the schedule. The default play list does provide for date and time changes, but with the adding or downloading of additional play lists, it is possible to modify and customize the broadcast as desired. To do this, the broadcast content is prioritized on client player device 6 to indicate which play list is to be played and how it is to be played. If there is an error, the system will default to the default play list as described above.

As mentioned, media player 82 allows each client player device 6 to generate and keep a log of the events of the previous session, such as the broadcast content played, at what time the content was played, the frequency of the content played, and any errors that occurred during playback of the content. This log is uploaded to central server 4 allowing the server administrator to inspect and analyze the log and fix any problems that have occurred.

Finally, media player 82 allows client player device 6 to generate a “proof of play” for advertisers. A “proof-of-play” is commonly known in the advertising art and basically indicates or declares that the ad was indeed played at its agreed upon and designated time, etc. The “proof-of-play” can be provided to the advertisers based upon the session log generated by the client, and can be given to them in any media format, such as a hard copy, email, or on CD, etc.

Updater. Updater 84 is an application that uploads ads played, music version information, and software version information to the central server(s) 4, receives new connection times from central server 4, gets new play lists from central server 4, and downloads any needed files referenced in the play list from central server 4. Updater 84 communicates with music or media player 82 component using XML-RPC, and is invoked by both music or media player 82 and client player device launcher 86 via system calls.

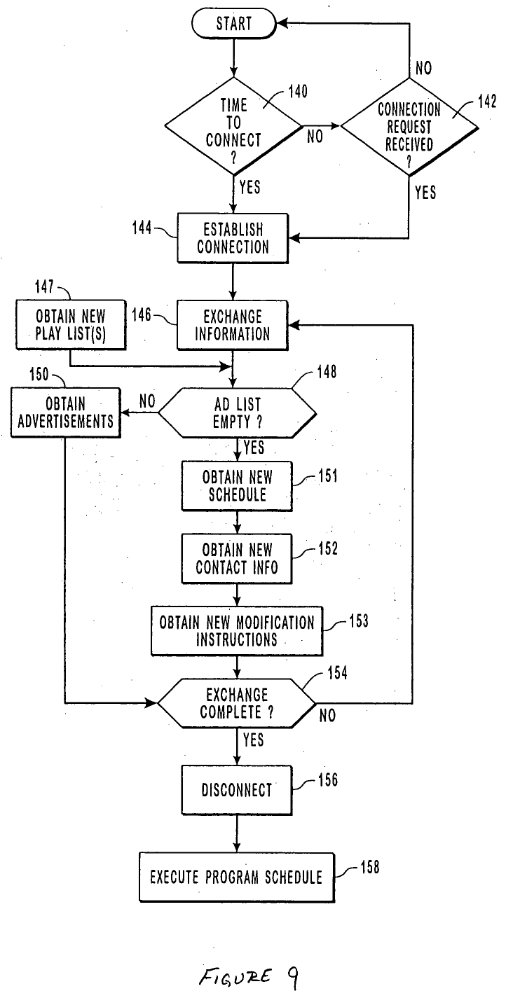

With reference to FIGS. 3 and 9, communicating with central server 4 using updater 84 in the manner provided herein, presents a unique advantage. For example, changing additional play lists, other than the default, is done from each client player device 6. Updater 84 allows each client player device 6 to be set up as a service, meaning that each client player device 6 sits and constantly listens for a communication from central server 4 for updates, instruction, etc. Moreover, at a scheduled time 140, client player device 6, through client player device launcher 86, will initiate contact with central server 4. When contact is made, either by central server 4 or client player device 6, client player device launcher 86 establishes an open line of communication 144 with central server 4 by opening a JDBC connection. Upon connection, an exchange of information 146 takes place. During the exchange, the first thing updater 84 does once this connection is established is upload all of the session or business information to central server 4. This session information comprises various details about the previous session, with a session being defined as the time period between contact of client player device 6 and central server 4. In this respect, central server 4 is apprised of all of the events from the previous session from the last time it communicated with client player device 6. Session information comprises, but is not limited to: 1) a detailed log of what was played or broadcast and when; 2) whether there were any errors that occurred, and the details of these; and 3) any new requests by the member participant. Other types of information may also be uploaded depending upon the particular setup and direction of the member participant. This communication and timing of communication with central server 4 is based upon code of the application software of updater 84 stored in each client player device 6.

Once all of the session information is uploaded to central server 4, updater 84 then takes or downloads updated information from central server 4. The downloading of updated information may comprise, but is not limited to: 1) receiving new or additional play lists 147 or individual songs; 2) receiving new advertisements 150 depending upon whether or not the inquiry 148 as to whether the ad list (described below) is empty is positive or negative; 3) receiving new broadcast schedules 151; 4) receiving new contact information 152 indicating when it is next scheduled to call in to the central server; and/or 5) receiving instructions 153 on modifying any of the broadcast content already existing on client player device 6. Once the exchange is determined to be complete 154, the connection is terminated 156 and the program schedule is executed 158.

As part of the download with respect to advertisements, updater 84 first downloads an ad list. This ad list comprises and identifies each advertisement that is to be downloaded to client player device 6 for the next session. If the ad list is empty, no new advertisements are scheduled to be played on client player device 6. If the ad list comprises one or more advertisements, then client player device 6 establishes an FTP connection with a file server having a database storing all of the available advertisements. updater 84 is then instructed to download all of the advertisements that are delineated in the ad list. The file server database may be located on central server 4 itself or on an independent server.

Each advertisement, no matter how it is procured, is eventually stored into the file server in order to allow updater 84 to obtain the advertisement through the FTP connection. There are several ways in which advertisements are supplied to the file server, some of which include: 1) supplying advertisements from the member participants themselves; 2) supplying advertisements from an ad agency or similar business; and/or 3) having the in-store media broadcasting system administrator or operators put the advertisements on the file server themselves.

Each client player device 6 is programmable as desired by the respective member participant. In addition, each client player device 6, through client player device launcher 86, is capable of initiating a manual update rather than waiting for the scheduled update. Manual initiation may be desirable if errors are occurring during the session broadcast or if the member participant wants to change something about the broadcast immediately (e.g. the wrong ad is being played, the member participant running a grocery store just ran out of oranges and further broadcast of these is undesirable, etc.). essentially, updater 84 enables all exchange of information between each client player device 6 and central server 4.

Client Player Device Launcher. As stated, client player device launcher 86 is an application that launches updater 84 either at the scheduled time or on demand. Preferably, updater 84 is launched at least once per week, and at most once per day. Client launcher 86 includes connectivity specific programs such as ring-daemon (which listens for incoming calls), connection establisher, and IP address poster. Client player device launcher 86 invokes updater 84 via system calls. Client player device launcher 86 also includes two additional capabilities specifically for dial-up configurations. First, for every execution of updater 84, client launcher 86 initiates a dial-up connection, handling PPP authentication and addressing, logging errors, and trying as necessary to connect within a configurable time duration. Second, client launcher 86 includes the ability to launch updater 84 on demand. This is accomplished via the ring-daemon, which listens for an incoming call, clears the line, and executes updater as described above.

Upgrader. Upgrader 88 is an application that upgrades the software and/or media files of the in-store media broadcasting system. Upgrader 88 does not communicate with any other client player device application modules. Upgrader 88 is a program responsible for the actual updating of music and/or software on a client player computer. The program also logs its status and handles error conditions. Updater 88 supports versioning of music and/or software and will not run an upgrade that is at or below the current version on the system.

Central Server(s)

FIG. 3 further illustrates central server(s) 4 and the several application sub-components existing thereon that allow the central server to function as intended. Specifically, central server 4 comprises a file storage device 92, a remote file access 94, a business objects 96, a data store 95, and web applications 98.

File Storage Device. The present invention central server 4 features a file storage device or component 92 that comprises one or more physical storage devices (e.g., hard disk drives, tape drives, and optical disk drives) to hold files (e.g., audio and video files) that need to be provided to client player device 6. File storage device 92 utilizes application software to communicate with remote file access 94, business objects 96, and web applications 98 using Network File System (NFS), a client/server application that allows users to access shared files stored on computers of different types. NFS provides access to shared files through an interface called the Virtual File System (VFS) that runs on top of TCP/IP. With NFS, computers connected to a network operate as clients while accessing remote files, and as servers while providing remote users access to local shared files.

Remote File Access. The present invention central server 4 features a remote file access component 94 that comprises one or more file servers (e.g., an Remote file server) to provide a means of transferring files (e.g., audio and video files) to client player device 6. Remote file access component 94 communicates with file storage component 92 also using NFS.

Business Objects. The present invention central server 4 features a business objects component 96 that is the layer that models and enforces business rules and/or data of a business location or organization. It includes the JIMBean components. Business objects component 96 communicates with file storage device 92 using NFS. Business objects component 96 communicates with data store component 95 using Java Database Connectivity (JDBC), which is a Java application program interface that enables Java programs to access database information. JDBC translates a Java program's data queries into commands the database management system understands. Business objects component 96 also communicates with web applications component 98 using Remote Method Invocation (RMI), a set of protocols developed for Java objects that enables them to communicate remotely with other Java objects.

Data Store. The present invention central server 4 features a data store component 95 that is the business data layer that models and enforces business rules and/or data of an organization. Data stores include music, advertisements, field services, chains, contracts, and schedule information. Data store component 95 communicates with business objects component 96 using JDBC, and web applications 98 using Open DataBase Connectivity (ODBC), a standard database access method. The goal of ODBC is to make it possible to access any data from any application, regardless of which database management system is handling the data by translating the application's data queries into commands that the DBMS understands.

Web Application. The present invention central server 4 features a web application component 98 that is the Web accessible presentation to business objects component 96 and data store component 95. It includes both web-based reports and applications utilized by network personnel to manage business functions (e.g., contract and advertisement management) and view business information (e.g., connection reports). Web application component 98 communicates with file storage device 92 using NFS, with data store component 95 using ODBC, and with business objects component 96 using RMI.

Central server system(s) 40, and particularly central server(s) 4, is/are essentially the brains of in-store media broadcasting system 2. Central server 4 schedules all of the advertisements, play lists, and other information to be downloaded to each client player device 6. Central server 4 comprises many of the hardware components described above, as well as other components known in the art, such as a network interface, which interfaces with a network, one or more application servers, and a storage device. As such, central server 4 is a standard server computing device as known and is capable of connecting, in communication, a plurality of client player devices 6, one or more chain managers 8, and a system network manager 10.

Central server 4 comprises or stores various music play lists, advertisements, announcements, etc. that are to be made available to each client player device 6 upon request. Central server 4 is operated by an administrator that coordinates and organizes the content provided to him/her and that is desired and specified by a particular member participant to be played at his/her respective business location.

Chain Manager(s)

FIG. 3 further illustrates chain manager(s) 8 and the several application components existing thereon that allow chain manager 8 to function as intended. Specifically, chain manager 8 comprises music manager 102 and player manager 104. A member participant operating a chain of business locations can use chain manager 8 and one or more of these application modules to perform many functions not available in prior art in-store broadcasting systems. The application modules or components existing within chain manager 8 may or may not reside on the same computer. In addition, it is preferable that no applications or components communicate with other chain manager applications or components.

Music Manager. The present invention chain manager 8 features a music manager 102 that is an application module used to manage play lists for groups of stores or business locations and business locations existing within a chain.

Music manager 102 is operable on client player device 6 and provides for the creation and maintenance of the default play lists for groups of business locations and business locations in a chain, if so desired. Music manager 102 also provides for the creation and maintenance of date and time sensitive play lists for groups of business locations and business locations in a chain, if so desired, and will allow the operator of chain manager 8 to assign music play lists to each business location within the chain.

Music manager 102 may be located on either of client player device 6, central server 4, or chain manager 8, but is preferably located on chain manager 8 in order to provide control of the several business locations within a chain.

Player Manager. The present invention chain manager 8 features a player manager 104 that is an application module used to control specific aspects of client player device 6 including starting or stopping of music or media player 82, starting or stopping of advertisements, moving or skipping media files, launching client updater 84, managing error logs, adding sound effects (e.g. from an equalizer, etc.), and setting the player device's volume. Player manager 104 is also used to view advertisements and media files that are scheduled to play or that have already played. Player manager 104 can also check, in real time, what is being played on any given client player device at any given time. Player manager 104 is an interface module.

Although, player manager 104 provides for monitoring and control of client player devices 6, such as those in a chain, it also allows each business location to maintain a pre-determined level of individuality. Thus, chain manager 8 is capable of controlling a large or a small part of the operations of each client player device 6 under its management or control.

Player manager 104 may reside on either central server 4, client player device 6, or on chain manager 8, but preferably resides on chain manager 8. When residing on client player device 6, at a business location, business location personnel are allowed to control the broadcasting system. When residing on chain manager 8, authorized personnel may control the broadcast of several client player devices 6 within the chain. In a chain of business locations, a member participant can have the autonomous control of the broadcast. However, if control is had at the business location level, member participants cannot stop third party ads. The only way third party advertisements may be stopped is by the system administer or other authorized personnel of the system network manager 10.

Chain manager 8, and particularly player manager 104, allows member participants, while not allowed to stop third-party advertisements, to do many things, such as display ad played information, display scheduled ads, display log entries, delete log entries, display a list of songs that have played and when played, stop scheduled in-store advertisements, skip currently playing media, move the media file to a different genre, delete a media file, launch the updater, start and stop the player, shutdown and reboot each client player device, query each client player device's status, create play lists, etc., for each business location within the chain, by connecting with each client player device 6 in communication with chain manager 8. These are only illustrative of some of the functions of player manager 104 of the present invention, and while not every function may be discussed herein, this is not meant to limit the functionality of player manager 104 in any way as the inventor intends that player manager 104 be able to control and manage any function of client player device(s) 6 and each in-store broadcast. Essentially, player manager 104 is intended to function to control each client player device 6 and the in-store broadcast of chain business locations at the very business location level.

Chain manager 8 is in communication with client player device(s) 6 and central server 4 as shown in FIG. 3. Thus, through player manager 104, although they are able to control a large part of the in-store broadcast within each business location, they are also in contact with central server 4 such that when a play list is created, these are subsequently uploaded to central server 4 where they are made available for download during the next call.

Another advantage of player manager 104 is that if a song or advertisement needs to be stopped, or if a play list needs to be modified or changed, chain manager 8 operator, through player manager 104, may communicate directly with the particular client player device 6 to perform such function. As stated, player manager 104 is designed to control each client player device 6 and its actual in-store broadcast.

Typically, a play list is specified and played based upon a percentage basis (e.g., 50% country, 30 percent 80's, etc.). Songs from these genres are randomly selected based on an algorithm, thus songs are not required to be played from the top of the directory to the bottom. Once a song is played, it is marked as “played” and won't be played again until all the other songs in that genre have been played. For example, in a given hour, 3 advertisements are scheduled for broadcast, with no specific times designated. Thus, player manager 104 divides three into sixty and plays one advertisement at the top of the hour, one at twenty after, and one at forty after. In between the advertisements, songs are played based on the randomization algorithm described above. If a song starts at eighteen after and the advertisement is supposed to start at twenty after, the song is allowed to finish and the advertisement starts immediately after the song ends. A song is never to be cut off in during playback. So, once client player device 6 dials in to the network and receives the advertisements, the songs, and the schedule (stating which ads need to be played in which hour), the information is organized accordingly by scheduling center 114.

In an alternative embodiment, the present invention contemplates that member participants of an individual business location will want to put their own CD in client player device 6 and populate the play list on the hard drive to contain the music on the CD. This is easily accommodated through the program modules described herein, and with each song or play list eventually being uploaded to central server 4.

Player manager 104 is essentially a web service, as the preferred choice of communication is via the Internet, thus providing the ability to remotely interact with each client player device 6 within the chain to perform many functions, such as those described above. In addition, this player manager 104 controls the audio dynamic range compressor or volume leveler built-in on each client player device 6. This volume leveler only modifies the output of songs, thus leaving the advertisements in their original state. This feature allows advertisements to be broadcast at a “hotter” (louder) level making them more apparent and noticeable to customers.

Player manager 104 also includes an on-demand application for dialup connections. With this application, a technician can call the phone number associated with the Linux box and then hang up. The modem monitor subsequently hears the call, clears the line, and then dials into the Internet Service Provider to establish a connection to the Internet. Through this connection, central server 4 is contacted and the IP address is posted. The technician will use the IP address to SSH to the Linux box.

Still another function of player manager 104 is to launch updater 84 that works as described above to perform the steps of: (1) connecting to the Internet (or other connection means); (2) connecting to central server 4; (3) uploading all “ad played” information currently residing on client player device 6; (4) querying the database to determine if there is a new play list to download; (5) connecting to the remote file server; (6) downloading the computer's hotFix items, if any; (7) downloading advertisements and play lists; and (8) logging out of central server 4's database and sign off connection.

Regarding step one, networked business locations will preferably always be connected to the Internet through the business location's WAN. These have a permanent IP address. Dial-up stores will have to connect upon demand through a dial-up ISP, wherein they will receive a temporary, dynamic IP address.

Regarding step two, each client player device 6 is capable of connecting to central server 4 using the IP-based Java database connectivity (JDBC) protocol. A client player device will login to the database where it is identified by hostname alone. The changing of IP addresses in dial-up stores will not affect the login procedure. A connection record including the current connect time is generated for each login.

Regarding step three, after central server 4 database acknowledges that is has received the “ad played” information, the ad log files are removed from the local computer.

Regarding step four, if there are items to download, the computer proceeds to step 5. If not, the computer proceeds to step 8.

Regarding step five, each client player device 6 connects to the remote file server using IP-based Protocols. Each client player device 6 pulls the remote file server's IP, port, login, password, and relative directories for advertisements, music, software, video, and other media from their associated connectivity setup in the database. The changing IP addresses in dial-up business locations will not affect the login procedure at this step either.

Regarding step six, in one exemplary embodiment, each business location has its own HotFix folder with the remote file server. If there is anything in the HotFix folder, it is downloaded to client player device 6's HotFix folder, and removed from the server.

Regarding step seven, each client player device 6 will download all new information pertaining to it. Each client player device 6 at each business location has its own XML folder within the remote file server. Advertisements and ad play lists, music and music play lists, video and video play lists, music upgrades, software, and other media for a business location can be pulled from a global, chain, group, and/or business folder level within the remote file server. The location of advertisements is determined when creating the business location's schedule in the control center.

All currently scheduled items (ads, play lists, etc.) must be downloaded for the update to be considered successful. If an advertisement or a play list fails to download for whatever reason, that item is left marked as needing to be downloaded and the update proceeds. As the download process proceeds, each item is marked as downloaded after each successful transfer via XML-RPC. This allows the update to keep track of which items still need to be downloaded, even if the connection is terminated before completion.

Regarding step eight, the computer updates its connection record after each update. The update's status (e.g. whether all items were uploaded/downloaded successfully) is also recorded. The current time is also recorded as client player device 6's disconnect time. Client player device 6, or updater 84, then logs out of central server 4 until its next scheduled connection.

System Network Manager

FIG. 3 further illustrates system network manager 10 and the several application components existing thereon that allow system network manager 10 to function as intended. Specifically, system network manager 10 comprises control center 112, scheduling center 114, reports 115, music library manager 116, database sync 117, and field support application 118. A network administrator can use one or more of these application components to perform many advantageous functions not found in prior art in-store broadcasting systems. This suite of application components may or may not reside on the same machine. None of the application components herein communicate with other system network manger application components.

Control Center. The present invention system network manager 10 features a control center 112 that is used by system network manager 10 personnel to create and maintain chain, store, group, music configuration, user, and advertising category information. Control center 112 is also used to create and maintain information pertaining to the several business, advertisement, and other contracts. It is also used to manage date and time sensitive music play lists for chains, groups, and stores, as well as user privileges.

Control center 112 serves to perform many functions, including, but not limited to: 1) being responsible for creating and maintaining the records of each business location, such as for a chain of business locations (e.g. Safeway, Albertson's, etc.), an individual business location, or a group of one or more business locations; 2) being capable of creating and maintaining and modifying the music configurations to be provided to the various business locations; 3) being capable of creating and maintaining and modifying default and date/time sensitive play lists for business location chains, individual business locations, or groups of business locations; 4) being able to create and maintain and modify advertising categories; 5) being capable of creating system user and set access privileges; 6) create, edit, and delete business locations, either individually or in chains or groups; 7) assign business locations to groups; 8) set the number of times in-store and revenue ads can be played; 9) set volume; 10) set connectivity information for a business location (either network or dial-up); and 11) assign stores to play lists. These are not meant to be limiting, but only illustrative of some of the features of control center 112.

The music provided by in-store media broadcasting system 2 of the present invention is a baseline service. The music play lists and advertisements in the file server are downloadable on a daily, weekly, monthly basis via the Internet or other means of connection with central server 4. In regards to the songs and the advertisements, certain things must be known about each in order to operate upon them, such as to start and stop them, etc. Simply naming them is not enough. Therefore, control center 112 has been created to operate on the songs and advertisements. Any songs received in a format other than .mp3 format are converted or ripped to the .mp3 format and then entered into the database. In the .mp3 format, two things are done to them: 1) a header program is run against them, which populates the header with all the information needed to make the software work;. 2) another program is then run against it to take out all the dead spaces.

TM Century is the preferred music provider that (see Business Methods section for description) provides weekly updates of new songs. TM Century's library is approximately 20,000 songs large, each categorized in different genres. These are not necessarily the content that is provided to the stores, however. The present invention system is capable of modifying and expanding this content (e.g. expanding the genres) as desired. This is done at the control center level and by control center 112. As such, there is not a simple pass through of this content from TM Century to the present invention system and then to the various business locations. Instead, each song or play list is operated upon to provide optimal broadcasting services. Essentially, when song files are ripped to the .mp3 format, they are categorized in central server 4 database. The information for populating the header comes from the information in the database. The header looks to the database to tell what the song or advertisement is based upon or what it was called when entered into central server 4 database.

Control center 112 is also capable of directing and delegating a portion, or all, control of the broadcasting system to the member participants, rather than the control center and central server(s) 4 controlling every aspect of broadcasting system 2. In this respect, the member participants and the individual business locations function or act similar to control center 112 in that they are allowed to carry out those functions of control center 112 that are relegated to them. Essentially, they can act like the control center if such an arrangement is agreed upon.

In order to allow a member participant and his/her associated business location to function in this manner, the necessary proprietary software is loaded directly onto their PC or server. Once this is done, they are equipped to function as the control center for their particular business location(s). Although a portion of the control of the broadcasting system for a particular business location may be relegated to its operating member participant, control is never entirely given up. The only portion of control relegated is the control of their server centrally with the network of the present invention so that control of that is transferred to them. Essentially, the present invention software and operating system can be integrated to run on their network, but with all other functions and control of the present invention system as described herein preferably remaining with system network manager 10 and control center 112 to ensure quality product/service control.

Finally, control center 112 functions using platform independence between each client player device 6. This allows each client player device 6 to be serviced and operated upon independent of any other client player device 6. This is advantageous and unique from the prior art because this allows business locations and member participants to fully customize their in-store broadcast without having to be limited and constrained by other member participants or third parties. Furthermore, control center 112 is capable of going from client to client with the code and/or operating system as found on central server(s)/file server(s) 44.

Scheduling Center. The present invention system network manager 10 features a scheduling center 114 that is used to manage in-store contracts, revenue contracts, business contacts, advertisements, and the scheduling of advertisements to contracts.

Scheduling center 114 functions to create, edit, and submit for approval pending revenue contracts (see Business Methods section below), and to specify specific business locations, dates, exclusivity, categories, and slots for the contracts. Scheduling center 114 also functions to resolve any conflicts between contracts.

Scheduling center 114 is responsible for specifying the particular business location(s) for a specific contract. Thus, once a contract is procured, that contract may be designated to be applicable to one or more business locations depending upon the agreement reached in the contract.

Scheduling center 114 also determines the exclusivity of a contract, which means if a particular advertisement is assigned a specific category, no other advertisements may be played in this category during the assigned or designated broadcast slot. Categories may include anything ranging from business location products, such as soft drinks, chips, bicycles, etc., to slots for the contracts.

One of the primary function of scheduling center 114 is to resolve any conflicts existing or discovered between procured contracts. This is accomplished using an algorithm that goes through and compares everything before a contract is allowed to be activated. If there is a conflict, that contract is not allowed to go active. Conflicts are resolved preferably by changing a contract, but may also be done by canceling a contract that is in conflict with another.

Scheduling center 114 also provides for the viewing of active revenue contracts or in-store contracts. Revenue contracts are the third-party contracts (see description in Business Methods section below). In-store contracts are the in-store advertisements that are currently being played or that are scheduled for play that day. Conflicts and other aspects relevant to in-store contracts are similar to those for revenue contracts.

Scheduling center 114 essentially provides for sufficient management of revenue, in-store, and business contracts procured in accordance with the method of doing business as described herein. Each contract is preferably stored on central server 4 using a user table having no privileges set so that all contracts, all member participants, and/or all advertisers are stored in one location.

Scheduling center 114 further functions to allow a person of authority to view pending contracts, approve contracts to go active, view contracts being scheduled, activate approved and non-conflicting contracts, and to view active contracts.

Under the business plan disclosed herein, sales people are responsible for selling and procuring contracts with advertisers and member participants. Once contracts are procured, they must be approved prior to being activated. This is typically done through a sales supervisor or some other management or authority personnel through use of the contract module.

As defined herein, a contract is related to a block of time specific to advertisements and advertisement details (e.g., date, time, number of times to be played, etc.). A contract is simply a block of time that an advertiser buys in a particular business location, business chain, or group of business locations.

Scheduling center 114 also functions to manage all of the ad files in the file server and all of the advertisements approved to go active within in-store media broadcasting system 2.

Scheduling center 114 also provides for the creation of an “ad place holder,” which is a temporary holding and preparation feature for the procured advertisement. Within the “ad place holder” you have certain steps that must be performed before the advertisement becomes or is considered a completed advertisement ready for download to a business location. First, a sound file must either be uploaded or created that is to be associated with the advertisement. Second, the advertisement goes through the process of being viewed and approved by a team of personnel, such as an ad engineer, a production artist, or by the producer, etc. This level of approval is done at the ad file level. Third, the advertisement must clear inspection by a primary supervisor that approves and makes the determination as to whether an ad is a completed ad file and ready for broadcasting. The supervisor then activates that ad file.

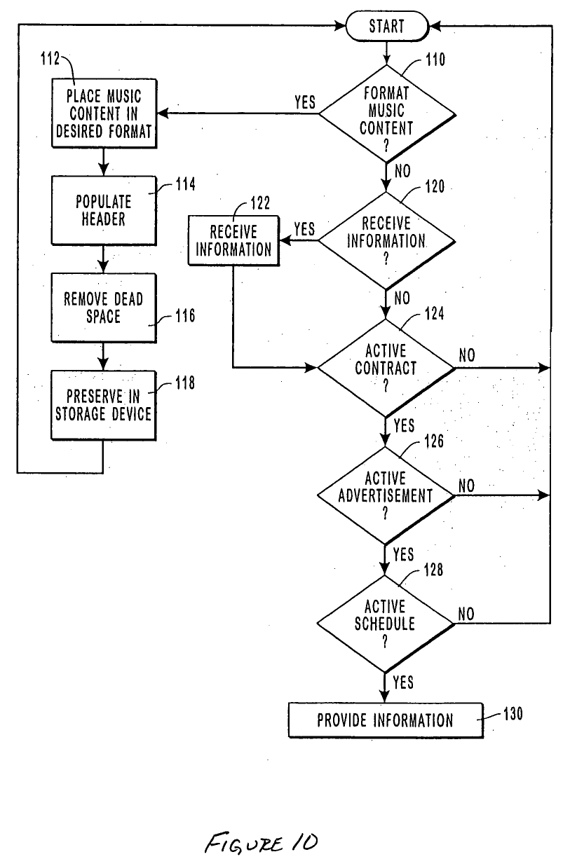

Referring to FIG. 10, illustrated is the method of providing an in-store broadcast according to the present invention using the scheduling center described herein. First, as stated above, music media is received 110 and formatted 112. Once formatted, the music is operated upon to populate the header 114, remove dead space 116, and preserve the music in the storage device or file server 118 on the central server. Once the music is formatted other information may be received 120 and 122. This information typically will comprise various advertisements, announcements, etc. Once the ad file and the ad contract are allowed to go active, this still is not enough for the in-store media broadcasting system to automatically perform as it is intended to perform. In all, three conditions are designed to be met. First, an active contract must be obtained and activated 124 (see description above). Second, an active ad file must be obtained and activated 126 (see description above). And, third, an active schedule must be obtained and activated 128. The activation of a schedule is performed by a scheduling module 66. Once these three conditions are satisfied, the content is provided 130 to a business location to comprises an in-store broadcast.

A further function of scheduling center 114 is to associate a contract with an advertisement. Once associated, it is possible to structure a play schedule for that advertisement. At this stage, any conflicts between contracts should have already been resolved. If there is a conflict in contracts, the system will not operate. However, under some embodiments, it may be possible to override a conflict and schedule.

As soon as an active contract, an active advertisement, and an active schedule are created, the system and database is ready to provide the proper client player device 6 the relevant information and play schedule. Therefore, the next time client player device 6 calls in to communicate with central server 4, this newly created information is made available to client player device 6 for download. If any one of the three above described conditions are not met, then client player device 6 receives nothing as no information would be available. As stated, communication with central server 4 may be scheduled for any time, or may be done at the request of the member participant, etc., but is preferably made on a weekly basis. Any available information is then exchanged, along with the report of the last weeks events by client player device 6.

Reports. The present invention system network manager 10 features a reports component 115 that is used to view various reports of the system. Some of these reports include: 1) connectivity reports; 2) scheduling reports; 3) billing reports; 4) advertisement reports; 5) sales reports; and 6) database sync reports.

Music Library Manager. The present invention system network manager 10 features a music library manager component 116 that is used to create, maintain, and manage media files and genre classifications and to upload media files to related genre folders. Media library manager 116 is also used to define music library versions.

Database Sync. The present invention system network manager 10 features a database sync 117 that is an application module utilized to update business location information located within the central server databases with information from the chain databases. On a scheduled basis, database sync 117 establishes database connections, locks records, and updates database records. Database sync 117 also is used to synchronize the chain store repository and data store component 95.

Field Support Application. The present invention system network manager 10 features a field support application 118 that is used by the deployment and installation team to maintain client player devices 6. Using field support application 118, reports can be viewed (e.g., installation histories), trouble tickets associated with installations can be managed, and connectivity testing can be performed.

Network Communication

The communication between each client player device 6 and central server 4 may be accomplished using various connection means as known in the art, but is preferably done using a network configuration, such as a dedicated network configuration or through a global user network such as the Internet. A dial-up configuration may also be used.

Again referring to FIG. 2, one or more network interfaces 24 enable each client player device 6 to exchange information with one or more other local or remote computer devices or servers 36 via a network 38 that may include hardwired and/or wireless links. Examples of network interfaces 24 include a network adapter for connection to a local area network (“LAN”) or a modem, wireless link, or other adapter for connection to a wide area network (“WAN”), such as the Internet. Network interface 24 may be incorporated with or peripheral to client player device 6. In a networked system, accessible program modules or portions thereof may be stored in a remote memory storage device. Furthermore, in a networked system each client player device 6 may participate in a distributed computing environment, where functions or tasks are performed by a plurality of networked computer devices.

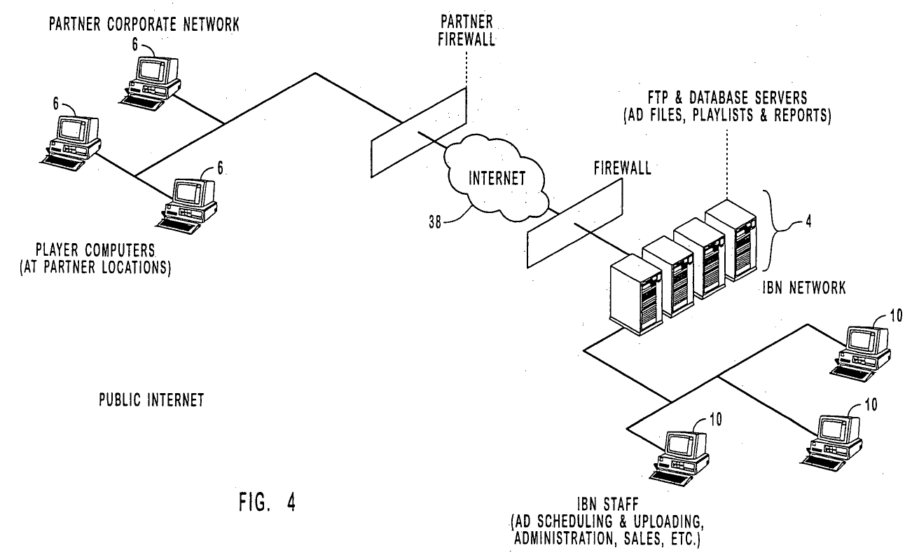

FIG. 4 shows generally the network setup of the in-store media broadcasting system 2 using a global user network, such as the Internet, as described above. This is one exemplary embodiment of a connectivity configuration.

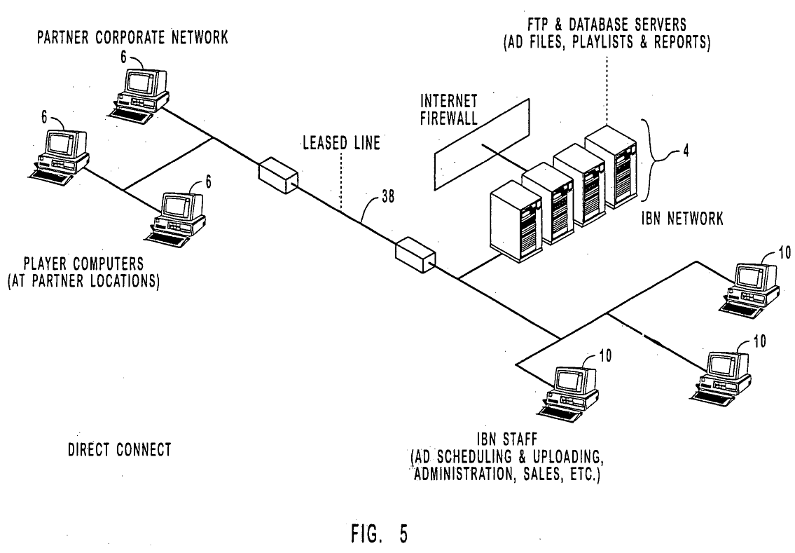

FIG. 5 illustrates generally an exemplary network setup of the in-store media broadcasting system 2 using a direct connect dedicated network configuration. In this configuration, central server(s) 4 are in direct communication with client player devices 10 through a leased line.

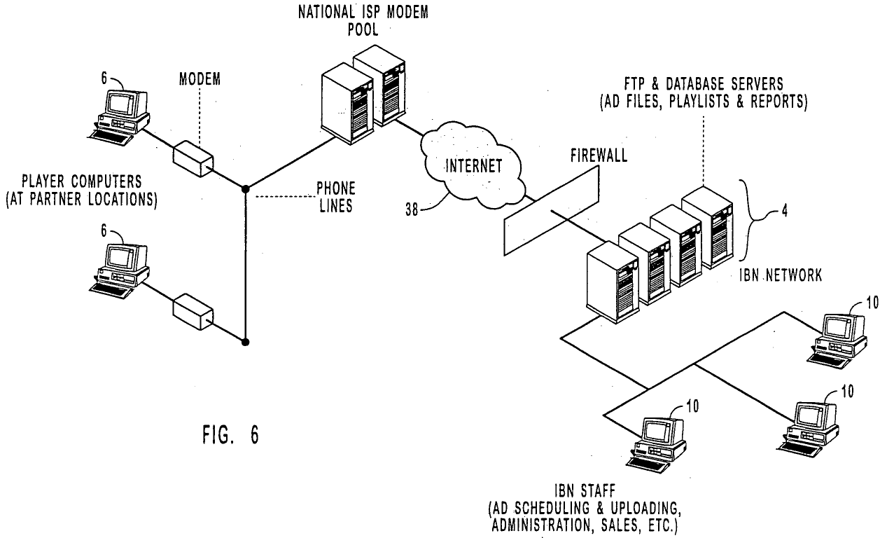

FIG. 6 illustrates generally the setup of the in-store media broadcasting system 2 using a dial-up connection. In this configuration, a temporary IP address from a national ISP is obtained to connect the client player device 6 to the Internet 38 and to central server(s) 4 using a modem.

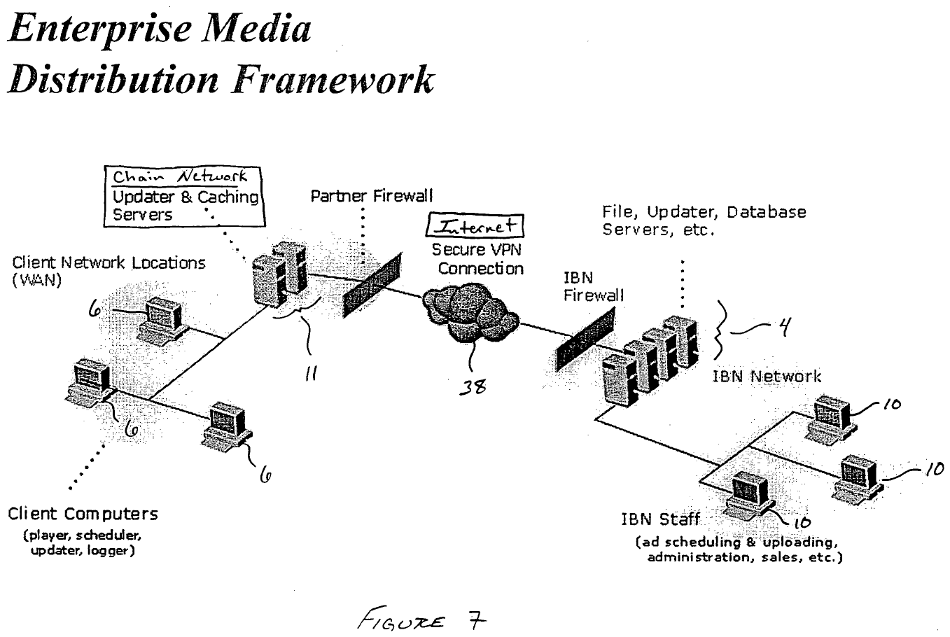

FIG. 7 illustrates generally an operating environment of an exemplary, and preferred, media distribution system. In this particular embodiment, the media distribution system comprises a business chain (not shown) having a plurality of business stores (also not shown) at various business locations. The media distribution system further comprises an enterprise media distribution framework or platform comprising a plurality of client player devices or media distribution modules 6 placed at different business locations throughout the business chain. Each client player device 6 is network connected to a chain server system 11 within a chain network and communicates with the server system 11 as directed. One unique aspect of this system is the function of the chain server system 11. Unlike the system described above, the system shown in FIG. 7 allows chain server system 11, comprising various servers, such as an updater server and a caching server, to communicate directly with each of client player devices 6 existing within the business chain rather than each client player device 6 communicating with central servers 4. Stated differently, chain server system 11 assumes several of the functions of the central server system 4 in the system described above with respect to FIGS. 1-6. Specifically, client player devices 6 communicate with chain servers 11 for the same purposes they communicated with central server system 4 as described above. However, in this particular system, central servers still exist to communicate with chain server system 11, albeit to a much more limited degree. This prevents client player devices 6 from having to talk or communicate outside the business chain network because networks 11 perform the function of talking to servers 4.

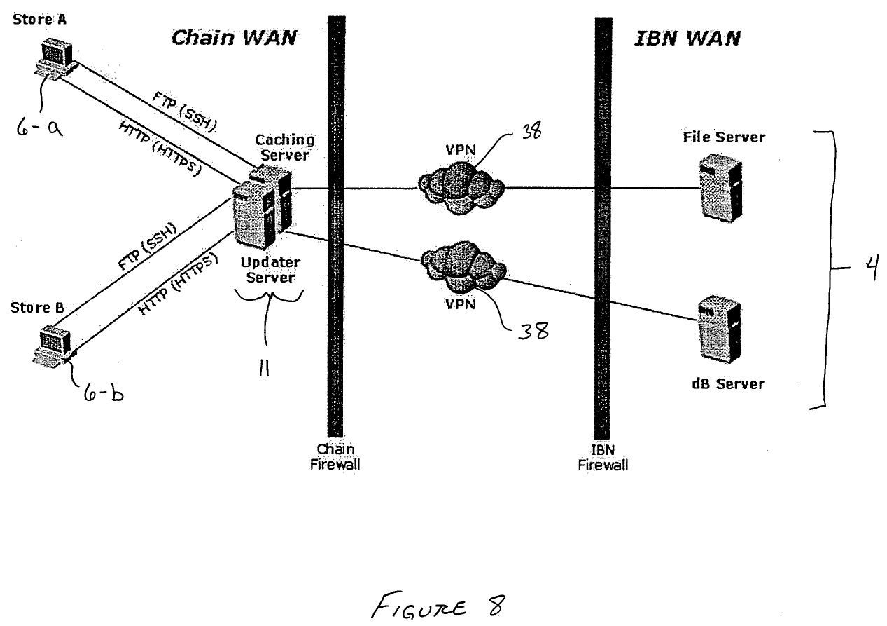

FIG. 8 illustrates a more detailed view of one particular chain business utilizing the media distribution system of the present invention according to the exemplary operating environment in which a chain server system is utilized as the first degree communications center for each of the client player devices existing and in operation within the business chain. FIG. 8 shows client player device 6-a in one remote location and client player device 6-b in another remote location. Each of client player devices 6-a and 6-b are in communication directly with chain server system 11. Chain server system 11 functions to exchange information, such as media information, with each of the client player devices 6-a and 6-b, and others within the business chain. In addition, chain server system 11 functions to communicate and exchange information with central server system 4, which may be in communication with a plurality of chain servers, each one servicing their own respective business chain and associated client player devices.

Client player devices 6 communicate with chain server system 11 using FTP, SSH, HTTP, HTTPS, and/or other common protocols. In addition, the communication between client player devices 6 and chain server system 11 may be in accordance with the technology taught and disclosed in co-pending U.S. patent application Ser. No. 10/146,192, incorporated by reference herein in its entirety. In addition, chain servers communicate and exchange information with central server system 4 over a VPN secured internet connection 38.

Chain server system 11 preferably comprises a caching server and an updating server. The caching server functions to retrieve files from central server system 4 and to store these files for later access. Each client player device in operation within the business chain accesses the caching server for the necessary files needed for distribution of the in-store broadcast. All of the necessary files contained on the central server that are to be downloaded to the chain server system are downloaded to the caching server. Specifically, the caching server services include: a) outgoing (through VPN to central server system) using HTTP or NTP, which can be set up to use internal server if necessary; b) outgoing (through Intranet to client player device)—none, as this is handled by the updater server; c) incoming (through Intranet from client player device) using HTTP; and d) incoming (through VPN from central server) using common ports, such as NRPE or SSH.

The Updater server functions to serve as proxy and communicates with the central server system. In addition, the updater server exchanges information with each of the client player devices. Specifically, each client player device in operation within the business chain downloads and uploads information from the updater server. The updater server services include: a) outgoing (from chain server through VPN to central server) using commonly known ports, such as JDBC or NTP ports, which can be setup to use internal server if necessary; b) outgoing (from chain server through Intranet to client player device) using HTTP; c) incoming (to chain server through Intranet from client player device) using HTTP; and d) incoming (to chain server through VPN from central server) using HTTP, NRPE, or SSH. In one exemplary circumstance, the updater server downloads the necessary files needed for the in-store media broadcast for a particular day, as retrieved from the caching server, to each of the client player devices. At the end of the day, each client player device uploads to the uploading server any information pertinent to the in-store broadcast, various requests for new files or new media content, problems encountered, reports, and any other relevant information. The updater server then communicates with the central server as needed.

Utilizing a chain server system, the client player device provides many services including: a) outgoing (from client player device to Updater Server through Intranet) using HTTP; b) outgoing (from client player device to Caching Server through Intranet) using HTTP; c) incoming (through Intranet from Updater Server) using HTTP; and d) incoming (through Intranet from Updater Server) using SSH.

In another exemplary situation, chain server system facilitates efficiency in the updating process. For example, as scheduled, the client player devices in operation within the stores of a business chain make HTTP calls to the updater server for the purpose of uploading ad played information, for getting new advertisement/music/video playlists, for getting a list of advertisements to download, etc. To respond to the update, the updater server makes a JDBC connection with the central server over a secure VPN Internet connection. All information is exchanged, and the necessary upgrades retrieved and downloaded to the caching server. The various business locations then make HTTP connections to the caching server to download any new media and/or information (advertisements, announcements, etc.) retrieved by the updater server. If an ad does not already exist in the caching server's file cache, the caching system automatically downloads (via HTTP) requested ad and other data from the central server over a secure VPN connection. As each file is successfully downloaded, an acknowledgement is sent to the updater server that prevents duplicate downloads if connection is prematurely severed. The player checks for updates and then checks for software updates (the player downloads music and software files in the same way as it downloads advertisements). Each client player device at the various chain business locations then send a “connection complete” message to the updater server indicating that the updating process is complete. It should be noted that any on-demand connects are accomplished by the updater server by sending an HTTP notification to each client player device. After notification, the client player devices proceed as above.

Essentially, the chain server utilized in this particular media framework, its functions, etc., is/are similar to the central server described above. Many of the aspects and tasks of the central server performed above are, in this embodiment, performed by the chain server. This allows the chain server to better manage and control the broadcasts being broadcast to the various business locations within the business chain. For example, each client player device preferably exchanges broadcast and broadcast-related data with the chain server rather than the central server. The central server still functions to receive and store broadcast data and information. This information or data is then downloaded to the various chain servers existing and in operation within the enterprise media distribution system.

Use of the chain server system is beneficial in that it provides for a more evenly distributed computer system. Rather than communicating and exchanging information directly with each client player device in operation (whether for the same or different chains), each chain is able to assume a more integrated and management-oriented role. Each chain is able to maintain and manage their own server system, thus providing more control to chain managers over the media and/or information being broadcast to their respective business locations. Moreover, the computing load is distributed throughout the chains, rather than the central server system.

Another advantage to providing a chain server system is the increased efficiency of the in-store broadcasting network, the increased security of the system as each chain is able to exercise greater and more autonomous control, and the increased overall ease of operation of the in-store broadcasts.

Still other advantages are made possible, particularly to chain managers or chain partners. First, each is given enterprise-level control with the ability to offer client or client-side control through the network system's client control software discussed herein. Second, chain servers provide access to greater bandwidth that allows for richer media content. Third, there is an increased ability to deliver real-time and near real-time announcements, such as public service messages, emergency messages or announcements, etc. chain wide. Fourth, upgrades and routine system maintenance is improved because these may be done at the local chain level. Fifth, each chain server system comprises caching capabilities, which reduces partner bandwidth usage.

### Method of Doing Business to Provide In-Store Media Broadcasting to a Plurality of Business Locations

The business model or method of the present invention features an in-store media broadcasting network (IBN) functioning to offer an in-store media broadcasting service to various retail and service provider businesses, as well as offering a national radio-advertising network that is focused on retail businesses (e.g., shopping malls, major supermarkets and drugstores) and service providers (e.g. hospitals, dentists offices, etc.), with an emphasis on major supermarket and drugstore retailers. The present invention system and method gives merchants, such as retailers, and service providers the ability to broadcast customized music and messaging directly to their customers. In addition, the method of the present invention provides a targeted advertising venue for consumer marketing companies that are interested in advertising their products to customers at the point of sale.

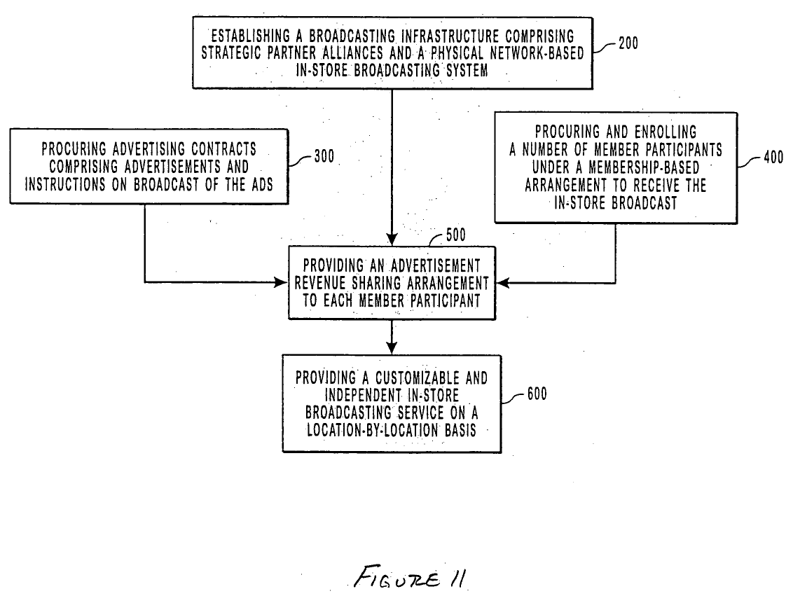

With reference to FIG. 11, illustrated is a flow chart showing, generally, the method of providing an in-store media broadcasting system according to a preferred embodiment. Step 200 comprises establishing a broadcasting infrastructure including strategic partner alliances and a physical network-based in-store media broadcasting system. Step 300 features the procuring of advertising contracts comprising advertisements and instructions on broadcast of the advertisements. This step is intended to be on-going as new advertisements and ad partners will be continuously sought. As such, this step can take place at any time. Furthermore, step 400 includes procuring and enrolling member participants under a membership-based arrangement to receive the in-store broadcast. This step is also ongoing and is intended to apply at any time throughout the offering of the service. Step 500 includes providing an advertisement revenue sharing. arrangement to each member participant. This arrangement is discussed in greater detail below. Finally, step 600 includes providing a customizable and independent in-store media broadcasting service on a location-by-location basis as described above.

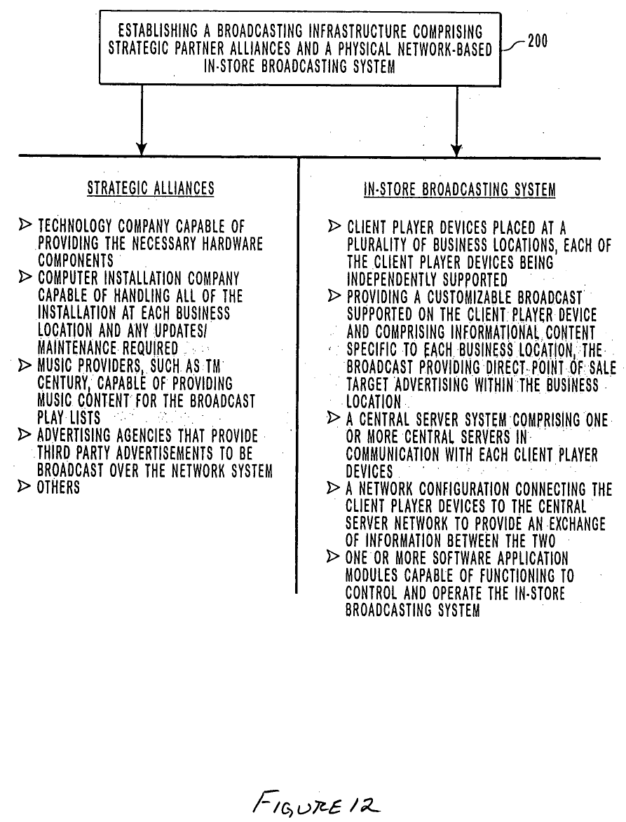

Referring to step 200, to conduct the business as described herein, it is advantageous to form strategic alliances capable of providing technology capabilities, computer installation, maintenance and service, as well as those necessary to provide the music library to be offered to each business location. It is also advantageous to provide an in-store media broadcasting system and service as that described above. Each of these are shown in FIG. 12.

Music Media Sources

One of the advantages of the present invention business method is the unique partnership arrangement contemplated in which music and digital music files are provided. These music files are formatted, stored, and are made ready for immediate download and subsequent broadcast over the in-store media broadcasting network to each member participant. In one embodiment, a partnership arrangement is made in which a third-party entity, such as TM Century, provides the music to be broadcast to the several business locations. The music files may be provided in any recorded media or any format, but are preferably compressed media files, such as .mp3 or .wav files. The compressed media file format affords high quality audio with minimal hard disk storage requirements. The music is provided and stored in a database on the one or more central servers. This database is available to each client player device upon establishment of communication with the central server, wherein any one or more songs may be downloaded to the client player device. In addition, the song database may be updated as often as necessary. For example, the music database or library may be updated with new songs on a quarterly basis, provided, after review, that the new music meets certain content and other defined criteria, such as appropriateness. Once updated, any client player device may tap into the central server using its designated means for communicating with the central server, the updates typically occurring via FTP, HTTP, HTTPS, or CD.

Due to delicate copyright and proprietary rights to the various songs, jingles, etc. that are to be broadcast using the present invention in-store media broadcasting service, the business model of the present invention further contemplates partnership arrangements with one or more organizations, such as BMI (an American performing rights organization), that represents songwriters, composers, and music publishers in all genres of music; or one or more membership associations, such as ASCAP, comprised of composers, songwriters, and publishers of every kind of music worldwide. In the case of the representative organization, these organizations function to collect license fees on behalf of those American creators it represents, as well as thousands of creators from around the world who chose representation by that organization in the United States. The license fees collected for the “public performances” of its repertoire of compositions—including radio airplay, broadcast and cable television carriage, Internet and live and recorded performances by all other users of music—are then distributed as royalties to the writers, composers and copyright holders it represents. Such partnership arrangements are required to provide the music to be broadcast throughout each business location.

Computer Installation and Maintenance

Another strategic alliance is the partnering with an installation and maintenance company. When a new member participant joins the in-store media broadcasting service and network of the present invention, each member participant is given direct support and training with the goal of establishing an appropriate roll-out schedule. Personal computers or client player devices are then acquired according to that schedule and sent in for configuration and testing. The ad scheduling software, network interface software, and default music library are loaded on the client player devices at this point.

For member participants with relatively few stores, for example fewer than 300, all of the installation and setup may be handled internally. For larger member participants, those having over 300 stores, it is desirable to outsource the configuration, setup, and installation to an independent company capable of performing such a task on a national or international scale. Thus, the present invention further comprises an installation partnership with one or more companies capable of providing network design, installation, and maintenance on a local market basis.

Once configured, the client player devices are then sent to the closest local office of the designated installation partner. The employees of the installation partner then proceed to install the client player devices at each business location. At each site, the installation partner is responsible for connecting the client player devices to the network hub and the audio or audio/visual system of the business location. Once these connections are made, the client player device is turned on and the initialization process begins. During initialization, a file is automatically sent via the means for connecting (e.g. the Internet) from the on-site or in-store client player device to the central server. The central server then sends back a play list and ad scheduling instructions as well as instructions on when to reconnect or re-establish communication.

Although not a strategic alliance, but instead handled in-house, the present invention further comprises a customer support or customer service center that handles all the technical issues once each of the client player devices are running. The customer support center receives daily connectivity reports and therefore can proactively address issues as they arise with each business location. As part of the customer support, any problems may be resolved via telephone. However, if necessary, a new computer may be sent directly to the business location, to the member participant's headquarters, or to the local installation partner's office via an expedited delivery service, such as next-day delivery, etc. The new client player device can then be installed the next day to ensure that downtime is kept to a minimum.

Another feature is the ability to provide a backup in case there is a problem experienced. Therefore, the present invention contemplates a backup system in which a number or computers may be placed with local installation partners in order to eliminate any downtime at all. If a problem occurs, the business location's in-store broadcast may be switched over to be received or broadcast from the backup compute.

For a waivable or non-waivable monthly fee, owners and/or operators of a business location have free access to their own private label radio network based on a music library of thousands of songs in a plurality of genres. As part of the service, all necessary hardware and software, installation, maintenance, service and support are provided, maintained, and updated as needed. Music on hold over telephones and the production of a select number of store-generated advertisements is also contemplated and included.

Advertising Model

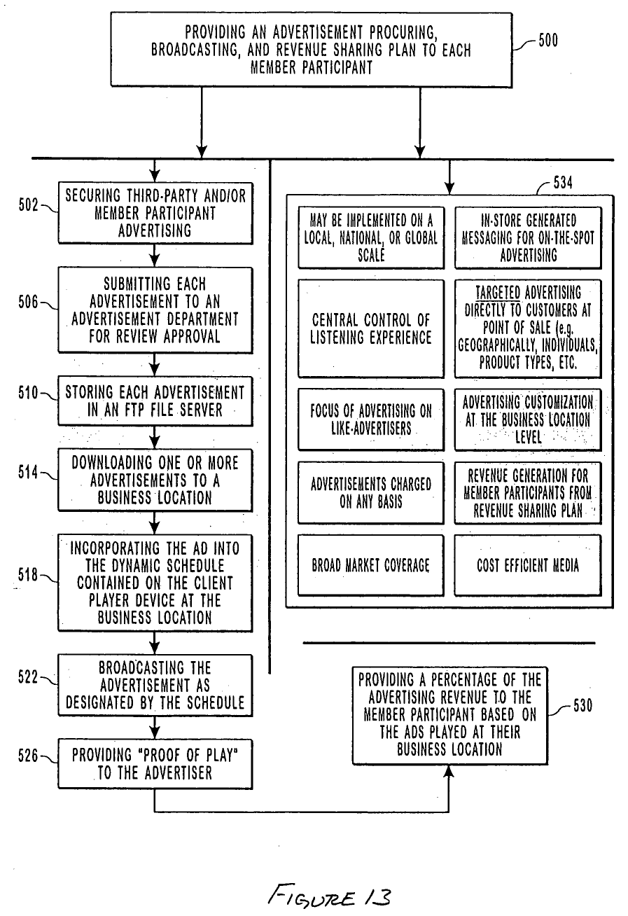

The present invention further features an advertising plan/model and method to be implemented with and unique to the in-store media broadcasting capabilities as presented herein. With reference to FIG. 13, step 500, providing an advertising procuring, broadcasting, and revenue sharing plan to each member participant comprises the specific steps of 502, securing third-party and/or member participant advertising; step 506, submitting each advertisement to an advertisement department for review and approval; step 510 storing each advertisement in an remote file server; step 514, downloading one or more advertisements to a business location; step 518, incorporating the advertisement(s) into the dynamic schedule contained on the client player device at the respective business location; step 522, broadcasting the advertisement as designated by the schedule; step 526, providing a “proof-of-play” to the advertisers; and step 530, providing a percentage of the revenue received from the advertiser to the member participants based upon the advertisements played in the member participant's business location.

In the retail industry, it is a well-acknowledged fact that environmental music enhances the shopping experience and leads to increased sales. Therefore, the cost of implementing an in-store music and broadcasting system using traditional means was justified by the return achieved on the investment. Retailers also use in-store music as a means to enhance brand building—shoppers will identify specific retailers by the type of music that is played. Despite the advantages of traditional in-store media broadcasting, however, for most retailers in-store music is a significant operating expenditure. Unlike prior part broadcasting systems and the business methods used to provide these, the broadcasting system and business method of the present invention enables those participating in the service (member participants) to greatly enhance the effectiveness of their in-store music programming. The present invention technology offers both retailers/service providers and advertisers an unprecedented level of flexibility, customization, and target marketing that is difficult to obtain with the prior art satellite based system. In addition, the delivery service offered by the in-store media broadcasting system of the present invention reduces overall operating expenditures, thus allowing member participants to offer lower prices to retail customers, while enjoying higher revenue earnings. Some of the recognized advantages of the present invention are: 1) revenue generation for the member participants from a revenue sharing plan; 2) a highly valuable and targeted advertising audience for advertisers; 3) advertising customization by the advertisers and advertising and system customization by member participants; 4) broad market coverage; and 5) cost-efficient media. These are illustrated in FIG. 13 as advantages 534.

In regards to revenue generation for the member participants from a revenue sharing plan, in the preferred method of operation, member participants make a percentage on all advertising that is sold. This revenue will eventually offset the monthly fees and transform the in-store media broadcasting system into a revenue generating system for each of the member participants involved.

In regards to providing a highly valuable targeted advertising audience for advertisers, shoppers are a very attractive and desirable targeted audience because their demographics are appealing and these shoppers make purchase and activity decisions for the entire household. For example, supermarket shoppers are attractive targets for advertisers. At least one member of virtually every household shops at the grocery store so the depth and breadth of coverage is tremendous. The typical supermarket shopper is female, over the age of 18 and is a primary target for a wide range of personal care, food and household products. In addition to being a strategic audience for these advertisers, grocery store shoppers are also the gatekeepers for other household purchasing—they buy the products needed to feed their families and keep their households running. This audience often makes activity decisions for the family—for example which movies they will see, which television programs they will watch and where they will go on vacation. Thus, advertisements related to these and targeted to the specific type of shopper will be highly effective. This type of advertising and potential success is difficult to attain with traditional advertising methods. Moreover, point of sale targeting directly to customers by advertisers is achieved because it is possible to have customers hear the ads as they are broadcast over the audio system of the business location right before they make purchases, advertisers can actually close sales with advertising. This is virtually impossible to do with traditional advertising media (radio, TV, print).

In regards to advertising customization by the advertisers and member participants, the in-store media broadcasting system and method of the present invention offers an unprecedented level of complete customization of the listening experience. Advertisers may run ads in individual stores, groups of stores, regionally and nationally. In addition, they can run ads at a specific time of day and can make weekly changes to advertising content (for example: orange juice in the morning, or chicken from 5-7 pm), as well as being able to change their ad content and schedule from week to week or month to month or at any desired time. This gives advertisers the ability to run special promotions during specific events. For example, People Magazine may require weekly scheduling flexibility to support each cover as it arrives at the newsstand. Furthermore, advertisers can target specific individuals, groups of individuals, products, services, etc. Still further, advertisements can be directly tied to outside influences, such as weather, sports games, seasons, etc. These ads can be automatically triggered to play upon the happening of one or more events or influences, or they may be manually triggered.

As a result of the proprietary technology utilized, customization is made possible on a business location by business location basis. In other words, customization of messaging and music mix is achieved down to the individual store. In addition the present invention method and system offers day-part advertising, which allows advertisements to run at a specific time of day. The present invention is capable of accommodating the broadcasting wishes of each member participant. As mentioned, traditional competitors are limited by their satellite-based broadcast systems and therefore it is virtually impossible for them to offer the same level of customization.

In regards to broad market coverage, in-store media broadcasting currently ranks in the top five listening audiences for radio stations in every market it serves and is often the top listening audience. This is because everyone at some point or another visits a retail store or service location where such a network system may exist. Therefore, in-store advertising is ripe for the unique method and system of the present invention.

In regards to cost-efficient media, because of the large number of shoppers and the depth of penetration, the in-store media broadcasting system and method of the present invention can deliver ads at lower cost per thousand impressions (CPM) than traditional media. In addition, unlike TV and radio, those target audiences of the present invention system cannot lower the volume or change the station. Consumer advertising is an attractive route because these budgets are typically larger and the buys are generally longer term and national in scope.

Other advantages are also recognized. For instance, because the platform music delivery system can be installed and maintained at a significantly lower cost than that of similar offerings from companies with satellite-based systems, lower start-up and operating costs are required. In addition, free store-generated messaging is contemplated, in which each business location is given complimentary airtime to promote in-store programs, departments, specials and shopper loyalty programs. Furthermore, central control of the listening experience may be provided, wherein it is possible to give member participants the ability to centrally monitor, in real-time, what is being played in each individual store, as well as giving them the ability to centrally control music mixing and store-generated messaging. In addition, unlike TV and radio, listeners cannot lower the volume or change the station.

The system and method of the present invention enables focus of advertisements and promotional and sales efforts on like-advertisers, meaning for example, if a grocery store implements the in-store media broadcasting system of the present invention, those advertisers accustomed to advertising within the grocery store segment, will likewise find the system and method of advertising according to the present invention even more attractive. In the grocery store segment, these like-advertisers may include a wide range of aggressively advertised consumer goods categories such as food and beverages, over-the-counter drugs, health and beauty aids and household products. Whatever type of retail or service oriented industry, as there is often significant crossover between industries, the method of the present invention combines local in-store radio networks into Designated Market Areas (DMA's) and then combine these DMA's to offer national advertising coverage.

Although the following discussion centers around implementing the in-store media broadcasting system into retail stores such as grocery or drug stores, the present invention is designed to be much more expansive in scope. For example, the system and method may be applicable, but not limited, to other retail segments, such as convenience stores, auto parts stores and hardware stores, malls, airports, and virtually any other public or private location or venue wherein the consuming public may be found. Hence, the term business location is meant to include any such location or venue.

Basically, how the system and business method works is that a client player device is installed at the business location of each retail business or service provider that is connected to the store's internal network and audio/visual system, namely their audio system. The client player device contains a library of thousands of songs categorized in one or more ways, such as by genre, along with the particular retailer's or service provider's proprietary advertising, music scheduling, and delivery software. At an identified time, typically or preferably once a week, the client player device receives new advertisements, play lists, schedules, and delivery or play instructions from the central server via the specific communication protocol designated for that particular business location, where communication via the Internet is preferred. Once received, the client player device plays the advertisements and music according to the instructions received. Also during the scheduled communication time with the central server, the client player device uploads its session information to the central server to report the activities of the previous session, including any errors that may have occurred.

As part of the business method, third-party advertising is secured and sold. A significant advantage of the business and advertising method or model presented herein is that a percentage of the proceeds or revenue generated and received from the third-party advertisers, as well as others wishing to advertise on the system, is also shared with the member participant (e.g. the retailer, or service provider, etc.), thus enabling the member participant to transform what was once an operating expenditure into a revenue generator.

This advertising is then broadcast over a business location's internal audio/visual system as specified by the member participant through communication with the central server, and broadcast throughout the business location as dictated by the created schedule.

Although explained in greater detail below, the particulars of the business method presented concentrates on generating revenues from both retail music service subscription fees and advertising sales, with the sales of advertisements generating the largest percentage of revenues.

Consumer marketing companies spend advertising dollars in two ways: trade marketing (retail promotions and co-op programs) to directly increase store sales and consumer advertising to build brand awareness and loyalty. The business method is designed to capture a share of both the trade marketing and consumer advertising budgets, with a percentage of the revenue generated from these being shared with the member participants. Additionally, the business method of the present invention is designed to capture markets at both the local and regional level.

Retail account groups at product manufacturers typically make trade advertising budget decisions. Larger manufacturers have dedicated account representatives for major retail store chains who are responsible for the trade budgets in their respective chains. The primary objective of these budgets is to directly increase sales via promotional programs. Programs include newspaper free standing insert (FSI) advertising, checkout coupons and shelf talkers. Trade marketing budgets are typically smaller than consumer advertising budgets and require a direct return on investment. Trade advertising spending decisions can be made relatively quickly—in a two to three month time frame.

Advertising using the present invention system and method is attractive to trade marketers because it is an effective way to reach shoppers while they are in the store, and right before they make their purchases. Trade advertising is attractive to the owners and operators of the present invention because of its relatively short sales cycle. It is also an effective way to fill fluctuations in capacity throughout the year.

With regards to a consumer advertising media plan, the primary objective is to reach as many people in a specified target audience as effectively and efficiently as possible. To evaluate these criteria, media planners compare options on a cost per thousand (CPM) target audience impression basis. Consumer advertising is typically sold via product manufacturers' advertising agencies. Agencies develop annual media buying recommendations that dictate quarterly spends by brand. They then work with product manufacturers to finalize the plans.

The advertising plan of the present invention is structured so that ads can be charged based upon any number of criteria. In a preferred embodiment however, advertisements are charged on a price per ad per store per week basis. The cost of the advertisements is flexible, but preferably will range from $20-$50. Discounts may be available based on criteria such as overall size of the package, marquee value of the member participant, and length of contract. Based on an average list price being $30, the estimated CPM for all the markets served will be approximately $0.94, which is significantly less than any prior art advertising methods.

To reach the targeted markets, the present invention contemplates advertising done on a local, regional, national, and international scale. Thus, sales of advertisements will be to large national and international companies and ad agencies, as well as to local and regional companies. This will enable member participants to have access to various advertisements at any desired level and from any type of vendor.

The primary objective of regional and local companies is to place geographically targeted messages within their specific trading area. These avenues are attractive to regional and local companies such as retail stores, automotive dealerships, government agencies, travel agencies, local media companies, health services and employment agencies because it is a much more effective way to reach local consumers than alternative media options.

The basis for running an advertisement may be derived from various criteria. An example of one such criteria would be to offer 30-second ads that run once per hour per store over a seven-day period. The number of stores and number of weeks would be dictated by advertiser need. A minimum time and store number may be imposed, however, if desired. In addition, strategies may be developed to create products that bundle business locations together within markets, markets within regions, and/or markets within demographic segments with specific ad packages. Stores fitting these criteria may be bundled together and sold as a package to advertisers. In all cases, product configuration will remain flexible and driven by advertiser needs.

Beyond the store, the present invention business method is designed to include in its list of advertisers those who target women, families and retirees. These advertisers may include, but are not limited to, television and entertainment companies, travel companies, theme parks, movie studios, and sports teams. Also included on this list are national and regional retailers that target women, families, and retirees.

Moreover, rather than just being limited on a national scale, the present invention is designed to be implemented on a global scale. For example, the supermarket segment offers a significant international opportunity because industry consolidation has been occurring on a global scale in recent years. In fact, five of the top 20 grocery retailers in the world are global players. Many of these companies have significant presence in the and outside the United States. Upon implementing the system locally, doing so on an international scale will entail little effort.

Although the present invention system and method is capable of being implemented in any number of business locations, the following examples are presented to show how the system and method function within several of these types of business locations. As such, these examples are not intended to be limiting in any way as one ordinarily skilled in the art will recognize the many possible alternatives and business location types that may utilize the system and method of the present invention in addition to the ones described herein.

### EXAMPLE ONE

There are 31,830 supermarkets in the country that accounted for $384.8 billion in 2000 sales. (Source of Figures in these two Examples: U.S. Department of Commerce, Retail Sales Estimates and Trends From 1991-2000 Chain Drug Review). Chain supermarkets and independent supermarkets are the two main segments of this retail segment. Many of the independents have joined co-operatives to increase their purchasing power. The inventors believe that both the chain supermarkets and the co-operatives represent significant sales opportunities. Currently, chain stores represent 64% of the total U.S. sales volume and 16% of the total number of U.S. supermarkets.

The following Table presents the represented figures pertaining to the grocery store industry:

| | | | | | % Total |
|---|---|---|---|---|---|
| | | | | Est. | U.S. |
| | | Number | | 2000 | Industry |
| | | of U.S. | | Sales | Sales |
| | | Stores ($2 | Names of Stores | ($ Bil- | ($384.8 |
| Rank | Company | million +) | Owned | lions) | Billion) |
| 1 | The Kroger | 2,366 | Kroger • King | $43.1 | 11.2% |
| | Company** | | Soopers • | | |
| | | | Ralphs • | | |
| | | | City Market • | | |
| | | | Dillons • | | |
| | | | Smith's • Fry's • | | |
| | | | QFC • Kessel • | | |
| | | | Cala Foods/ | | |
| | | | Bell Markets • | | |
| | | | Owen's • | | |
| | | | Jay C Food | | |
| | | | Stores • | | |
| | | | Hilander • | | |
| | | | Gerbes • Pay Less | | |
| 2 | Albertson's | 2,415 | Albertson's • | $31.5 | 8.2% |
| | | | Acme Markets • | | |
| | | | Jewel-Osco • | | |
| | | | Max | | |
| 3 | Safeway, | 1,482 | Safeway • | $29.0 | 7.5% |
| | Inc. | | Dominick's • | | |
| | | | Randalls • Tom | | |
| | | | Thumb • Vons • | | |
| | | | Genuardi Family | | |
| | | | Markets | | |
| 4 | Wal-Mart** | 908 | Wal-Mart | $23.0 | 6.0% |
| 5 | Ahold USA | 974 | Tops Markets • Bi- | $20.0 | 5.2% |
| | | | LoStop & Shop • | | |
| | | | Giant Food | | |
| 6 | Delhaize | 1,435 | Food Lion • Kash N | $15.0 | 3.9% |
| | America | | Karry | | |
| 7 | Winn-Dixie | 1,081 | Winn-Dixie | $14.0 | 3.6% |
| 8 | Publix | 645 | Publix | $13.0 | 3.4% |
| 9 | A&P | 820 | A&P • Food | $8.0 | 2.1% |
| | | | Emporium • | | |
| | | | Waldbaum's • | | |
| | | | Super | | |
| | | | Fresh • A&P Super | | |
| | | | Food Mart Farmer | | |
| | | | Jack | | |
| 10 | Supervalu | 539 | Cub Foods • | $7.2 | 1.9% |
| | | | Bigg's • | | |
| | | | Farm Fresh • | | |
| | | | Hornbacher's • | | |
| | | | Metro • | | |
| | | | Save-A-Lot • | | |
| | | | Shop 'n Save | | |
| 11 | H-E-B | 270 | H-E-B • Central | $6.7 | 1.7% |
| | Grocery | | Market | | |
| | Co. | | | | |
| 12 | J. | 165 | Shaw's | $4.0 | 1.0% |
| | Sainsbury | | Supermarkets • | | |
| | plc | | Star Markets | | |
| 13 | Pathmark | 138 | Pathmark | $3.8 | 1.0% |
| | Stores, Inc. | | | | |
| 14 | Military | 190 | | $3.6 | 0.9% |
| 15 | Meijer** | 144 | Meijer | $3.6 | 0.9% |
| 16 | Hy-Vee | 184 | Hy-Vee | $3.4 | 0.9% |
| 17 | Fleming | 200 | Rainbow Foods • | $3.1 | 0.8% |
| | | | Food4Less • | | |
| | | | Yes!Less | | |
| 18 | Raley's | 149 | Raley's • Bel Air | $3.0 | 0.8% |
| 19 | Giant | 120 | Giant Eagle | $2.9 | 0.8% |
| | Eagle, Inc. | | | | |
| 20 | Aldi | 697 | Aldi | $2.5 | 0.7% |

The recent consolidation of the grocery industry will increase the proliferation of the present invention system and method. According to published figures, the top five retailers control 38% of total supermarket sales compared to 29% ten years ago. This consolidation trend is expected to continue with the largest chains being the major benefactors. This will provide the system and method a built in mechanism for retailer growth.

From an advertising perspective, there is an enormous potential for growth as the typical grocery store carries over 25,000 products, many of which have substantial advertising budgets. In fact, CPG companies account for 30% of the $200 billion U.S. advertising market. Therefore, the grocery market represents a natural environment for the system and method of the present invention. Of the revenue generated by the advertising done at the business location of a member participant, a percentage of the received advertising revenue, typically 10%, would be provided to the member participants based on an agreed upon arrangement. Such a percentage would allow each member participant to profit from the broadcast of advertisements in their stores.

### EXAMPLE TWO

Drugstores represent another significant retail opportunity. In 2000, there were 20,298 traditional chain drug stores in the United States that accounted for $98.2 billion in sales. There are also 8,268 pharmacies in supermarkets that account for an additional $13.4 billion in sales or 12.0% of total industry sales of $131.8 billion that includes chain, independents, supermarket and mass merchandisers. The top four traditional drugstore chains control the majority of the market. The demographics of drugstore shoppers are also very attractive to advertisers. Women 18+ are again a large segment as are adults 55+. The following Table presents sales figures and other information pertaining to drug stores:

| | | | | % Total U.S. |
|---|---|---|---|---|
| | | | | Chain Drug |
| | | Number | 2000 Sales | Store Sales |
| Rank | Company | of Stores | ($ Billions) | ($98.2 Billion) |
| 1 | Walgreens | 3,165 | $21.2 | 21.6% |
| 2 | CVS Corporation | 4,100 | $20.1 | 20.5% |
| 3 | Rite Aid | 3,870 | $13.3 | 13.5% |
| 4 | Eckerd | 2,898 | $13.1 | 13.3% |
| 5 | Longs Drug Stores | 430 | $4.0 | 4.1% |
| 6 | Phar-Mor | 139 | $1.3 | 1.3% |
| 7 | Duane Reade | 193 | $1.0 | 1.0% |

Advertisements

One of the significant advantages of the present invention business method is the ability to sell and produce third-party advertising. As part of the service and method described herein, the present invention contemplates the creation and implementation of an ad production department. Therefore, once an ad is sold, the production department creates and schedules the ads for play in the stores. Those participating in the membership-based service of the present invention can forward pre-produced ads to the production department on a recordable media, such as on CDs or DAT tapes, etc. In addition, third-party sponsors (e.g., Proctor and Gamble, Kraft, etc.) may submit their ads to be played on any lever, such as on a local, regional, or national scale. The production department comprises a number of audio engineers that check the member submissions for quality, content, etc., and contact the member participant to resolve any issues. If the member participant does not have pre-produced ads, the production department further comprises copywriters, voice talent, and producers, each of whom work with the member participant to create the ads.

Once ads have been approved, they are transferred to the central server for download to the respective business locations. Advertisements can play at any time or at any frequency, with each ad typically playing once per hour during optimal shopping times—from 7 am to 11 pm daily.

As part of the advertising agreement reached with the ad sponsors, such as the member participants, third-party advertisers, and/or any advertising agency, each advertisement is played according to the stipulations and agreement reached with the ad sponsors. To verify that each advertisement was played as agreed upon, and after the advertisements have completed their assigned dates and times of play, each ad sponsor is sent a notarized “proof-of-play” report together with an invoice. A “proof-of-play” report is commonly known and used in the advertising industry. This report simply verifies that the ad was indeed played at its specified time and frequency as stipulated by the ad sponsor, and is generated upon receipt of the session report or log generated by each client player device and communicated to the central server at its scheduled time of communicating with the central server.

Music and Advertising Scheduling and Delivery Technology

The system and method utilizes proprietary client/server software specifically developed for music and ad scheduling and delivery. The software is java-based and therefore platform independent. Each week, the client software (supported on the client player device in the respective business locations) initiates contact with the central server via the designated means for communication, preferably the Internet, to request new ad downloads and play list instructions, and to upload play information from the previous session to the central server. Play information from the previous session is defined as information that states or reports session activity, such as which songs and which ads were played, when they were played, and how often they were played. The uploading of the session activity is preferably initiated by each client player device at the business locations, rather than by the central server, due to firewall issues—many internal firewalls block incoming data but will permit outgoing information.

Play list instructions will dictate the mix of music to be played (for example 50% Adult Contemporary, 25% Country and 25% Eighties). Play lists are configured centrally either by the in-store media broadcasting service provider or by the member participant. Member participants at headquarters may remotely access the central servers to perform a number of activities, including configuring play lists, manually overriding the auto-update feature to change play lists, real-time monitoring of what is being played on a location-by-location basis, and switching store-generated ads on or off. However, member participants are not allowed to access or change any third-party advertising.

After a third-party advertising contract has been sold, the sales representative creates an electronic contract in the software system. As ads associated with the contract are created, they are uploaded and assigned specific play instructions. Once the advertisements air, the play information is uploaded from the music servers in the stores into the central server databases and associated with their specific contract. This play information is uploaded periodically and is used to show “proof of play” to the ad sponsor and for billing purposes. Lastly, the proprietary network interface software allows easy interface with the member participant's internal network.

The following examples are illustrative of the particulars of the present invention discussed above. Again, like each Example presented herein, these Examples are not meant to be limiting in any way, but are merely provided to illustrate how the present invention system and method may be practically implemented.

### EXAMPLE THREE

An example of a large-scale member participant joining the present invention system and method may be that of Safeway, Inc. Safeway, Inc. contracted to participate in the in-store media broadcasting service in over 1,700 of its stores nationwide. With Safeway alone, an ad sponsor can reach upwards of 23.2 million shoppers in twenty markets across the country who shop for over $31 billion in supermarket goods annually. The terms of the Safeway contract are as follows: Safeway will provide the computers in each store. In return, in-store media broadcasting is provided free of charge. In addition, Safeway, Inc. was given up to a 39% revenue share on all advertising sold. As part of the agreement, Safeway, Inc. is responsible for all computer maintenance and service in each store. In this particular example, Safeway stores represent $10.6 million in annual potential advertising revenue (based on 60% utilization). The term of the contract was five years, with the provision that either party can opt out of the contract after the first year.

### EXAMPLE FOUR

In another relationship, a regional wholesaler/co-operative in Spokane, Wash., United Retail Merchants (URM), was contracted to become a member participant in the present invention in-store media broadcasting system and business method. URM has over 150 members in Eastern Washington, Northern Idaho, and Western Montana. Under contract agreements, URM members pay a monthly music subscription fee of $59 and receive an advertising revenue share ranging from $10 to $30 per month.

The previous Examples illustrate that many possible agreements or arrangements may be reached to carry out the intended functions and purposes of the present invention system and business method. However, in each instance, one primary advantage of the present invention business method is its ability to provide revenue to each member participant participating in the in-store media broadcasting service through various advertising agreements. Such revenue is not possible or even contemplated by prior art broadcasting systems or business models. As such, one ordinarily skilled in the art will recognize the several approaches that may be taken to carry out the intended functions and purposes of the present invention.

Subscription Plan

The present invention further comprises or features a plan for providing in-store media broadcasting services to select member participants on a subscription basis. The subscription fee will be significantly lower than what many member participants have been paying for in-store music services. The subscription fee arrangement will preferably be entered into with those member participants having fewer than 300 stores, but may also be entered into with any member participant. Many member participants will pay the subscription fee because first, they recognize that in-store media broadcasting is valuable; two, all of the hardware, software, and customer service will be provided, thus eliminating the need for the member participants to incur large upfront equipment expenses; and third, each member participant will be able to share in advertising revenue generated based on a percentage basis, which will more than likely offset and typically surpass any subscription fees owed.

The present invention may be embodied in other specific forms without departing from its spirit of essential characteristics. The described embodiments are to be considered in all respects only al illustrative and not restrictive. The scope of the invention is, therefore, indicated by the appended claims, rather than by the foregoing description. All changes which come within the meaning and range of equivalency of the claims are to be embraced within their scope.

What is claimed and desired to be secured by Letters Patent is:

1. An enterprise media distribution system comprising:
a system administration team;
a plurality of business chains, each comprising a plurality of facilities at respective business locations;
an enterprise media distribution platform or framework managed by the system administration team comprising:
one or more client player devices placed at each business location, each of the client player devices being independently supported and in communication with an internal audio/visual system installed in the facility at the respective business location;
an independent customizable media broadcast supported on each of the client player devices and comprising audio, visual, and/or informational media content thereon that may be specific to each of the particular business locations in which the client player device(s) is/are located;
a chain network system having at least one chain server servicing the business chain, said chain server in communication with each client player device in operation in the business chain by way of a network configuration facilitating the exchange of information between the client player devices and the chain server; and
a central server system comprising one or more central servers in communication with the chain servers by way of a computer network configuration facilitating the exchange of information between the chain and central servers.

2. The enterprise media distribution system of claim 1, wherein said customizable media broadcast comprises media selected from the group consisting of, audio data, video data fed to video screens located at a business location, advertisements, announcements, and other informational content.

3. The enterprise media distribution system of claim 1, wherein said chain server comprises an updating server.

4. The enterprise media distribution system of claim 1, wherein said chain server comprises a caching server.

5. An in-store media broadcasting system comprising:
a central server having a data layer;
a chain server having a data layer, wherein the chain server is connected to the central server via a computer network;
a client player device having a presentation layer for use in providing and controlling a customizable media broadcast, the client player device in communication with the chain server; and
an interface layer that selectively interacts with the data layer and the presentation layer, wherein control over the broadcast is experienced locally at the client player device.

6. A method for establishing an enterprise media distribution system for broadcasting media at one or more business locations existing within a business chain, said method comprising:
equipping a business chain with at least one chain server operable within a chain server system, said chain server operated and managed by business chain personnel;
connecting, via a computer network, said chain server to a central server system comprising at least one central server to facilitate the exchange of information between the chain server and the central server, said central server comprising broadcast data retrievable by said chain server;
connecting one or more client player devices located at respective remote business chain locations to said chain server system via a computer network to facilitate the exchange of broadcast and broadcast-related data between said chain server and said client player devices;
causing each of said client player devices to communicate with the chain server to exchange broadcast and broadcast-related data, said client player devices capable of running independent, customizable in-store media broadcasts.

7. The method of claim 6, wherein said chain server system comprises a local area network or business Intranet.

8. The method of claim 6, wherein said customizable in-store media broadcast is controlled substantially by said chain server.

9. The method of claim 6, wherein said customizable in-store media broadcast is controlled substantially by said client player device.

10. The method of claim 6, wherein said chain server comprises an updating server.

11. The method of claim 6, wherein said chain server comprises a caching server.
